(19) United States
(12) Patent Application Publication
(10) Pub. No.: US 2026/0350396 A1
(43) Pub. Date: Nov. 5, 2026

(54) GRAPH-BASED TASK DATA GENERATION

(71) Applicant: Arm Limited, Cambridge (GB)

(72) Inventor: Siyuan CHEN, Cambridge (GB)

(73) Assignee: Arm Limited, Cambridge (GB)

(21) Appl. No.: 19/657,759

(22) Filed: Apr. 24, 2026

(30) Foreign Application Priority Data
May 1, 2025 (EP) 25173882.9
Jun. 26, 2025 (GB) 2510248.4

(51) Int. Cl. G06N 3/082; G06N 3/042

(52) U.S. Cl. CPC G06N 3/082; G06N 3/042

(57) ABSTRACT

A processor configured to obtain chain data representative of a chain of subgraphs associated with a chain space and comprising: a first subgraph; an output operation to obtain output data from the first subgraph; an input operation to obtain the output data from the output operation; and a second subgraph to obtain the output data from the input operation. The processor is configured to, based on the chain data, determine an equivalence between at least one first local space dimension of a first local space associated with the output operation and a corresponding at least one second local space dimension of a second local space associated with the input operation and, based on the equivalence, update the chain of subgraphs to replace at least a combination of the output operation and the input operation with a connection corresponding to a logical pipe connecting the first subgraph to the second subgraph.

### TECHNICAL FIELD

The present disclosure relates to methods, systems, processors, and non-transitory computer-readable storage media for handling data for processing by a plurality of operations, such as neural network processing operations and graphics processing operations.

### BACKGROUND

Computational graphs are mathematical structures used to represent and organize sequences of operations in various computational systems. These directed graphs consist of nodes representing operations and edges representing the flow of data between operations. In computational graphs, each node performs specific functions or transformations on input data and produces output that may serve as input to subsequent operations. This approach to modeling computational processes has found applications in numerous domains including machine learning frameworks, compiler optimizations, parallel computing systems, and data processing pipelines. The structure of these graphs allows for visualization, analysis, and optimization of complex computational tasks by breaking them down into discrete, interconnected operations with well-defined inputs and outputs.

Processing operations in computational graphs presents several technical challenges that affect system performance and efficiency. When executing complex graph operations, computational overhead can accumulate as data moves through multiple nodes, particularly when the graph contains numerous small operations. Performance bottlenecks often occur at points where data must be transferred between different memory spaces or processing units, creating latency that degrades overall system performance. Additionally, inefficient data flow between operations can lead to unnecessary data copies, redundant computations, or suboptimal memory access patterns. These inefficiencies become more pronounced as the size and complexity of the graph increase, affecting both execution time and resource utilization. The scheduling of operations also presents challenges, as determining the optimal order of execution while respecting dependencies requires sophisticated algorithms.

Maintaining consistency across operations in computational graphs presents another set of technical challenges. As data flows through a chain of operations, each operation may have specific requirements regarding its inputs and outputs. Mismatches in these requirements can lead to execution errors or incorrect results. Managing these constraints becomes particularly complex in graphs with dynamic shapes or conditional execution paths. The transformation of data between different formats often requires additional operations which can introduce overhead if not handled efficiently. Furthermore, tracking and validating consistency throughout the graph requires additional computational resources and can complicate the graph optimization process. These consistency issues become more pronounced in applications such as tensor computations, image processing, and numerical simulations where precise handling of data is necessary.

Conventional approaches to graph optimization include memory optimization strategies that minimize data movement. Operation scheduling algorithms attempt to determine execution orders that maximize resource utilization while respecting dependencies between nodes. However, these approaches often operate with limited information about the data flow patterns across the entire graph, leading to locally optimal but globally suboptimal solutions. Traditional methods may struggle with complex dependency structures, particularly in graphs with control flow or dynamic behavior. Additionally, many existing optimization techniques focus on specific aspects of graph processing, such as computational efficiency or memory usage, without considering the interplay between these factors. This compartmentalized approach to optimization can miss opportunities for more comprehensive improvements that address multiple aspects of graph processing simultaneously.

### SUMMARY

According to a first aspect of the present disclosure, there is provided a processor configured to obtain chain data representative of a chain of subgraphs that represents at least part of a directed graph of operations. The chain of subgraphs is associated with a chain space and includes a first subgraph, an output operation to obtain output data from the first subgraph associated with a first local space, an input operation to obtain the output data from the output operation associated with a second local space, and a second subgraph to obtain the output data from the input operation. Based on the chain data, the processor determines an equivalence between at least one first local space dimension of the first local space to be iterated over to execute the output operation and a corresponding at least one second local space dimension of the second local space to be iterated over to execute the input operation. Based on the equivalence, the processor updates the chain of subgraphs to replace at least a combination of the output operation and the input operation with a connection corresponding to a logical pipe connecting the first subgraph to the second subgraph, thereby generating an updated chain of subgraphs. The processor then generates task data that describes a task to be executed in the form of a further directed graph of operations representative of at least the part of the directed graph of operations, based on the updated chain of subgraphs.

According to a second aspect of the present disclosure, there is provided a system comprising the processor according to the first aspect and an offload processor. The offload processor may comprise a command processing unit connected to a processing module. The processing module may comprise a storage with a plurality of storage elements and a plurality of execution units. The processor may be configured to issue the task data to the command processing unit.

According to a third aspect of the present disclosure, there is provided a method comprising obtaining chain data representative of a chain of subgraphs representative of at least part of a directed graph of operations. The chain of subgraphs is associated with a chain space and includes a first subgraph, an output operation to obtain output data from the first subgraph associated with a first local space, an input operation to obtain the output data from the output operation associated with a second local space, and a second subgraph to obtain the output data from the input operation. Based on the chain data, the method includes determining an equivalence between at least one first local space dimension of the first local space to be iterated over to execute the output operation and a corresponding at least one second local space dimension of the second local space to be iterated over to execute the input operation. Based on the equivalence, the method includes updating the chain of subgraphs to replace at least a combination of the output operation and the input operation with a connection corresponding to a logical pipe connecting the first subgraph to the second subgraph, thereby generating an updated chain of subgraphs. The method further includes, based on the updated chain of subgraphs, generating task data that describes a task to be executed in the form of a further directed graph of operations representative of at least the part of the directed graph of operations. Any feature described in the context of the processor or system of the first or second aspects may equally be present in a method in accordance with the third aspect.

According to a fourth aspect of the present disclosure, there is provided a non-transitory computer-readable storage medium comprising a set of computer-readable instructions stored thereon which, when executed by at least one processor, are arranged to cause the at least one processor to perform the method of the third aspect.

### BRIEF DESCRIPTION OF THE FIGURES

Examples of the present disclosure will now be described with reference to the accompanying drawings:

FIG. 1 is a flow diagram illustrating a computer-implemented method for processing a directed graph of operations and generating task data;

FIG. 2 is a block diagram illustrating a directed graph of operations;

FIG. 3 is a block diagram illustrating a producer subgraph and a consumer subgraph that form the directed graph shown in FIG. 2;

FIG. 4 is a block diagram illustrating a chain formed by combining the producer subgraph and the consumer subgraph shown in FIG. 3;

FIG. 5 is a block diagram showing a system for generating chains of operations;

FIG. 6 is a block diagram illustrating an initial merge process between a producer subgraph and a consumer subgraph to form a chain;

FIG. 7 is a block diagram illustrating a rewrite process for handling many-to-one input/output relationships when merging a producer subgraph and a consumer subgraph;

FIG. 8 is a block diagram illustrating a rewrite process to achieve production coherence when merging a producer subgraph and a consumer subgraph;

FIG. 9 is a block diagram illustrating a rewrite process to achieve consumption coherence when merging a producer subgraph and a consumer subgraph;

FIG. 10 is a block diagram illustrating a rewrite process comprising the formation of a logical pipe;

FIG. 11 is a block diagram illustrating a rewrite process that consolidates identical operations and/or logical pipes;

FIG. 12 is a block diagram illustrating a rewrite process that removes redundant logical pipes;

FIG. 13 is a block diagram illustrating a rewrite process that removes a redundant operation from a chain;

FIG. 14 is a block diagram illustrating a rewrite process that removes an unused dimension from a chain space;

FIG. 15 is a block diagram illustrating a rewrite process of chain with vector engine operations;

FIG. 16 is a flow diagram illustrating a computer-implemented method for processing chain data to generate task data;

FIG. 17 is a block diagram illustrating an arrangement for resolving connections between subgraphs in a directed graph of operations;

FIG. 18 is a block diagram illustrating a further arrangement for resolving connections between subgraphs in a directed graph of operations;

FIG. 19 is a block diagram illustrating various spaces associated with a chain of subgraphs;

FIG. 20 is a block diagram illustrating an arrangement for resolving connections between subgraphs in a directed graph of operations using augmented transforms;

FIG. 21 is a diagram illustrating a transformation between a chain space and a condensed chain space, via an intermediate chain space;

FIG. 22 is a schematic diagram illustrating a process for combining multiple affine transforms into a single combined affine transform;

FIG. 23 is a schematic diagram illustrating an example of a space transform optimization for affine and non-affine transforms;

FIG. 24 is a schematic diagram illustrating a further example of a space transform optimization for affine and non-affine transforms;

FIG. 25 is a block diagram illustrating a data processing system;

FIG. 26 is a block diagram illustrating a neural engine; and

FIG. 27 is a block diagram illustrating a system for allocating handling data.

### DETAILED DESCRIPTION

### Processing a Directed Graph of Operations

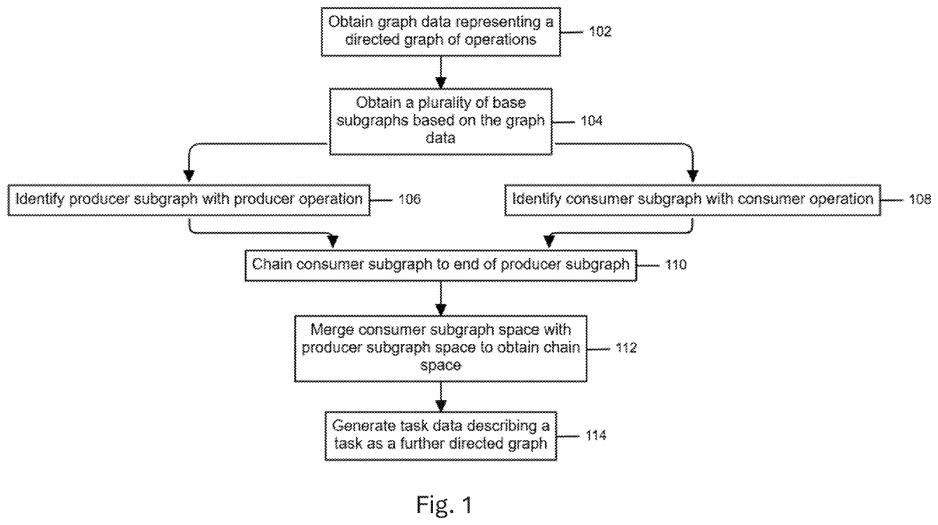

FIG. 1 illustrates a flow diagram of a computer-implemented method for processing a directed graph of operations and generating task data based on the directed graph of operations. The method begins at block 102, where graph data representing the directed graph of operations is obtained. The graph data may represent computational operations to be performed, such as neural network operations, matrix computations, or other computational tasks.

At block 104, a plurality of base subgraphs is obtained based on the graph data. Each base subgraph comprises at least one operation of the directed graph of operations. Additionally, each base subgraph is associated with a respective subgraph space defined by at least one dimension to be iterated over to execute the respective subgraph. The subgraph space represents the dimensional boundaries within which the operations of the subgraph are to be executed.

The method proceeds to block 106, where a producer subgraph is identified among the plurality of base subgraphs. The producer subgraph comprises a producer operation of the directed graph of operations, which is responsible for generating an output. The producer subgraph has an associated producer subgraph space that defines the dimensional boundaries for executing the producer operation.

At block 108, a consumer subgraph is identified among the plurality of base subgraphs. The consumer subgraph comprises a consumer operation of the directed graph of operations, which consumes the output generated by the producer operation. The consumer subgraph has an associated consumer subgraph space that defines the dimensional boundaries for executing the consumer operation. Although blocks 106 and 108 are shown at the same level within the method of FIG. 1, it is to be appreciated that they may be performed at least partly concurrently, fully concurrently or asynchronously, e.g. with block 106 performed before block 108 or vice versa.

The method continues at block 110, where the consumer subgraph is chained to an end of the producer subgraph to generate a chain of base subgraphs. This chaining process creates a sequence of operations that can be executed together as a unified task.

At block 112, as part of the chaining process, the consumer subgraph space associated with the consumer subgraph is merged with the producer subgraph space associated with the producer subgraph. This merging results in obtaining a chain space associated with the chain of base subgraphs. The chain space represents the combined dimensional boundaries within which the operations of both subgraphs are to be executed.

Blocks 106 to 112 may be performed repeatedly to merge additional subgraphs and/or chain(s) of base subgraphs with the chain of base subgraphs to iteratively update the chain of base subgraphs. This enables the generation of at least one chain of base subgraphs based on the chain of base subgraphs and representing the directed graph of operations (or a part thereof). In such cases, it is to be appreciated that the producer and/or consumer subgraphs identified at blocks 106 and 108 in subsequent iterations (e.g. after an initial iteration of blocks 106 to 112) may be base subgraphs or may be more complex subgraphs, for example a chain of base subgraphs obtained by merging two subgraphs, a subgraph and a chain, or two chains in a prior iteration of blocks 106 to 112.

At block 114, task data is generated that describes a task to be executed. The task data is in the form of a further directed graph of operations that is representative of at least part of the original directed graph of operations. This further directed graph comprises a chain of operations based on the chain of base subgraphs created in the previous steps. The task data can then be used by a processing system, such as a graph processor, to execute the task efficiently.

The method illustrated in FIG. 1 enables efficient processing of complex computational graphs by identifying and chaining together operations that have producer-consumer relationships. By merging producer and consumer subgraph spaces, the method creates optimized task representations that can be executed more efficiently than if the operations were processed individually.

The approach of merging subgraph spaces with different dimensionalities creates a unified chain space, which may be referred to herein as a chain space, which allows complex operations to be executed as a single task. This eliminates the need to process operations separately, which would require additional computational resources and time. The unified chain space provides a comprehensive dimensional framework that encompasses all operations in the chain, enabling more efficient execution of complex computational graphs.

By retaining the consumer and producer subgraph spaces of both the consumer and producer subgraphs during the merging process, dimensional information is preserved that would otherwise be lost in traditional transform propagation approaches. This preservation occurs without relying on operation-specific input/output transforms to propagate dimensional data. The complete dimensional information supports more complex operation spaces than previous methods that relied on relative transformations between spaces associated with different operations (also referred to herein as sections).

The described method eliminates the need for a primary operation concept that was central to previous approaches, making the system more adaptable across different architectures. This architecture-agnostic approach allows the same chaining methodology to be applied regardless of the underlying computational framework. The flexibility enables architecture-specific optimizations to be implemented while maintaining a consistent approach to operation chaining and space merging.

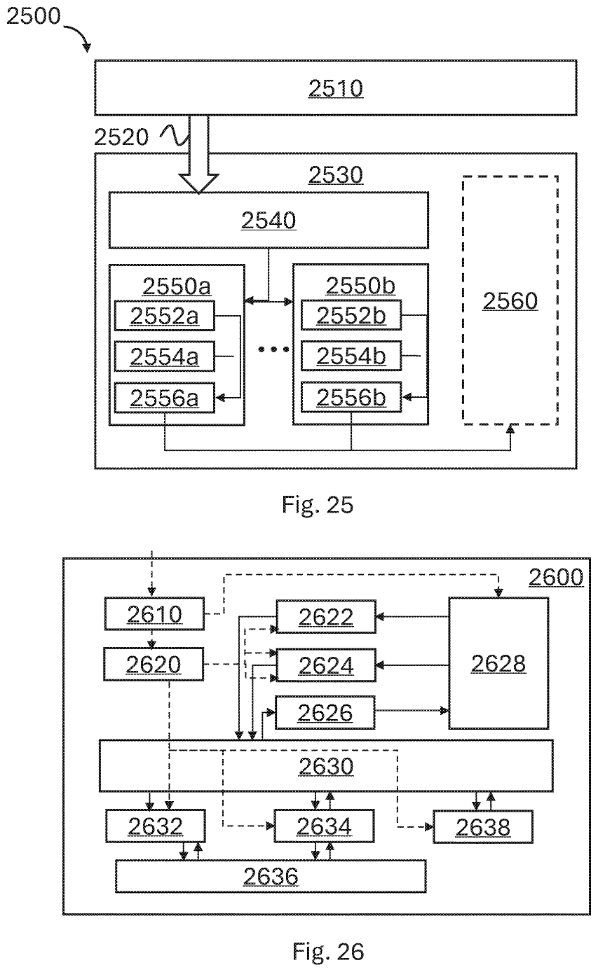

The methods herein, such as those in accordance with FIG. 1, can be used to obtain task data for a graph processor operable to execute the further directed graph of operations. For example, the approaches herein may be used to compile graphs for execution on a graph processor configured to operate on graphs of this form. Such a graph processor may be or comprise a neural engine and/or a neural processing unit, as described further below with reference to FIGS. 25 to 27.

### Directed Graph Structure for Operational Processing

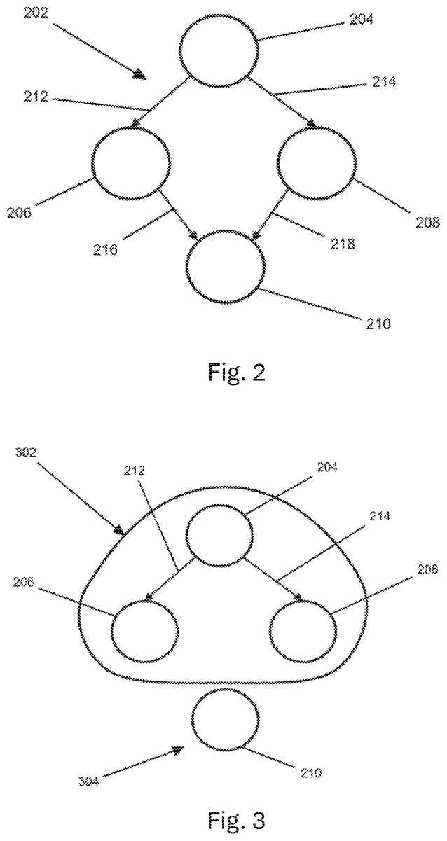

FIG. 2 illustrates a directed graph 202 that may be used in a processing system to represent operations and connections between operations. The directed graph 202 is a directed acyclic graph. Each connection corresponds to a different respective logical pipe, for transferring data between the operations connected by the connection. The directed graph 202 includes a first operation 204, a second operation 206, a third operation 208, and a fourth operation 210. The first operation 204 is connected to the second and third operations 206, 208 by first and second connections 212, 214, respectively. The second and third operations 206, 208 are connected to the fourth operation 210 by third and fourth connections 216, 218, respectively.

The directed graph 202 represents a computational flow where data progresses through a series of operations. Each operation in the directed graph 202 may represent a particular computational function, such as a neural network operation. The operations are arranged in a specific sequence to perform a desired computational task.

The first operation 204 may be configured to process input data and generate an output. This output is then transmitted via the first and second connections 212, 214 to the second and third operations 206, 208, respectively. The second operation 206 processes the data received from the first operation 204 and transmits its output via the third connection 216 to the fourth operation 210. Similarly, the third operation 208 processes data received from the first operation 204 and transmits its output via the fourth connection 218 to the fourth operation 210. The fourth operation 210 processes data received from the second and third operations 206, 208 and produces a final output.

Each operation in the directed graph 202 may have specific operational characteristics, such as dimensionality requirements, transformation rules, or reduction properties. These characteristics influence how the operations can be combined or chained together for execution by a particular processor, such as a neural engine.

The connections 212, 214, 216, and 218 represent data flow between the operations, and correspond to a logical pipe, which may be mapped to a particular storage element of a processor to execute the task by the processor. Each connection may carry tensor data with specific dimensional properties. The dimensional properties of the data flowing through these connections must be compatible with the input requirements of the receiving operation.

The directed graph 202 can be analyzed to identify sequences of operations that can be efficiently executed together. This process, known as chaining, involves determining which operations can be merged into a single task descriptor, represented by task data, which describes the task to be executed in the form of a further directed graph of operations. In the context of neural engine processing, the task data may be in the form of a Neural Engine Descriptor (NED) for execution on a neural engine architecture.

The directed graph 202 serves as the foundation for analyzing operation dependencies and determining optimal execution strategies. By examining the relationships between operations and the properties of the connections between them, a processing system can identify opportunities for optimization through operation chaining.

When analyzing the directed graph 202 for chaining opportunities, the system considers various factors including the dimensional compatibility between operations, the transformation requirements at connection points, and the hardware constraints of the target architecture for execution of a task represented by the directed graph 202. This analysis helps determine which sequences of operations can be efficiently executed together without introducing functional errors or performance degradation.

### Operation Space and Operation-Specific Local Space

When executing chains of operations, for example structured in a directed graph, each section could represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is a very large possible set of operators from which a neural network can be composed. The inventors have recognized that the possible set of operations from which sections can be formed can be hard to manage when seeking to design hardware to enable the execution (also referred to as “acceleration”) of these operations-particularly when chained together. For example, enabling fixed-function operation of each possible type of operation can result in inefficient hardware by requiring support for obscure or complex operations (sections).

In order to provide for a flexible traversal pattern when performing a task comprising operations on data, where the operations to be performed and the dimensions of the data may differ between different tasks, it may be advantageous to define a multi-dimensional operation space. In examples herein, a chain space for a chain can be considered to correspond to the operation space for the operations within the chain. Most operations on data in this context may be expressed as a nested for-loop with operations. For example, a 2D convolution operation on an input tensor may be expressed as a 7D loop of scalar operations. Consequently, defining a general operation space in a coordinate system having for example eight or twelve dimensions may provide a low complexity pattern for execution of any task comprising operations on data, instead of relying on fixed functions per task type, which may encompass a significant risk of missing necessary combinations of patterns. By defining a common operation space for a task (or a common chain space for a chain) in the form of a plurality of operations on data, it may be less complex to chain a plurality of operations to be executed on data to each other and coordinate execution of these operations.

Operation space dimensions do not have a specific interpretation until they are projected into a space for a specific task. This space is referred to as an operation-specific local space (or simply a “local space”), or section space, herein. Different operations having different types may be chained together by defining the common operation space for a graph corresponding to a chain of operations, referred to herein as the chain space, and then defining transforms from the chain space to each operation's individual local space, i.e. section space. Operation space is typically mapped to a specific operation's local space in the graph, with programmatic transforms provided for all other operations. As described herein, the transformation from operation space (e.g. chain space) to section space (e.g. local space), and therefore the management of compatibility and correct structuring of data between consecutive operations, is managed and issued centrally by a single handling unit based upon the dimensionality of a pre-defined operation space—e.g., by a descriptor that defines the operation space and the sections and pipes that form the graph.

When considering a directed graph structure, a given operation of the graph can be defined by a set of input and output transform matrices for that operation. The input and output matrices can then be applied to a block in operation space (e.g. chain space) to determine a range of values for the input and output of that operation. These ranges of values represent the operation-specific local space for that operation, which forms a local coordinate system on which that operation can be executed for that block of the operation space.

### Programmability of Operation Space to Section Space Transforms

The operation space for a task (e.g. a chain of operations representing at least part of a graph) may contain a pre-determined number of dimensions (e.g. eight or twelve) but the local section space for the operation to be performed for a specific section in that graph can contain fewer than the pre-determined number of dimensions. The handling unit may iterate through the operation space in units known as blocks, transforming each block from the common operation-space (e.g. a chain space) to a section-specific space (e.g. a local space) described by the various fields in a neural engine program descriptor (NED), which is a data structure stored in memory and retrieved by a processor (such as a neural engine) when executing the task issued (e.g. by a command processing unit) and represented by the task data derived using approaches described herein. The NED further describes at least a portion of a complete graph of operations (sections) to be performed when executing the graph of operations (e.g. representing a neural network). Sections may be mapped to various hardware execution units within the neural engine and essentially represent instantiations of a particular operator at a position within the graph. In one example, these sections are described by specific ‘elements’ that collectively define the operations forming part of the NED.

In an example implementation, the NED may further comprise for each element in the NED (e.g. each section/pipe) a program comprising transform program data that describes a transform from operation space (e.g. chain space, for a chain of operations) to section space (local space) for the corresponding section. In one such implementation, each element in the NED may comprise an offset value that points to the specific program within the NED for executing the transform. This offset value may be regarded as a pointer into ‘program space’, being the space in which all the programs which define the various enabled transforms are located. Alternatively, the offset value may be a pointer into a virtual address space in main memory. For example, this program space can be defined in the NED as a field tsu_space_size which for example is sized as 256 bytes. The offset may point to a memory location at which the start of its section-space transform is placed (e.g. the first instruction in a sequence of instructions which collectively define a program for performing the transform).

Each transform program may end with an explicit END instruction, and may be followed without any spacing or alignment by a next program defining a sequence of instructions for executing a different transform that is associated with a different element. Alternatively a starting pointer may be used in conjunction with a total number of instructions to execute.

In an example implementation, the sequence of instructions used for each transform may be selected from a set of pre-determined instructions which effectively form an instruction set. This instruction may be regarded as a transform instruction set which may be a specific set of instructions selected optimally to perform transforms from operation space to section space. Alternatively, the transforms may be general purpose instruction set as seen in a central processing unit (CPU).

In an example implementation, a transform instruction may operate on a set of state values for the transform. The state values comprise boundary registers (in one example eight boundary registers b[0] to b[7]) each comprising a low and a high component. Each block in the operation space is defined by the values described in the low and high components of the eight boundary registers. These values indicate the upper and lower bounds (inclusive) for the coordinates in the block for that axis of the “bounding box” operation space.

In this example, no other state is available to the instructions which operate to transform the operation space to a local section space for a specific operation to be performed. All operations performed by the instructions therefore operate on the boundary registers, including intermediate calculations.

Some sequences of instructions will transform one dimension at a time, starting with dimension 0 (e.g. b[0]) and work iteratively inwards through the dimensions. In other more complex sequence of instructions, more complex transforms may need to jump around by modifying the destination register identifier explicitly e.g. by using a SETD instruction in the set of instructions.

The result of executing the transform program for a specific block defines a block in section space (local space), ready to be used for the invocation of the specific hardware execution unit that is to execute the section. In the case of many types of operation to be performed by a hardware execution unit to execute a section, the execution unit does not use all the dimensions of a given section space. The handling unit therefore defines an invocation structure for each unit that defines the relevant requirements for that operation.

Having a complex chain of operations with multiple transforming operations may require complicated transforms to get from operation space to local space. Examples herein describe approaches for determining appropriate transforms from a chain space of a chain to respective local spaces of operations within the chain.

### Partitioning Directed Graphs into Operational Subgraphs

FIG. 3 illustrates features that relate to the directed graph shown in FIG. 2. In particular, FIG. 3 shows how the directed graph 202 can be partitioned into subgraphs for the purpose of chaining operations together.

As shown in FIG. 3, the directed graph 202 is divided into a producer subgraph 302 and a consumer subgraph 304. The producer subgraph 302 includes the first operation 204, the second operation 206, and the third operation 208 from FIG. 2. The consumer subgraph 304 includes the fourth operation 210 from FIG. 2.

The producer subgraph 302 represents a sequence of operations that collectively produce data that is consumed by the consumer subgraph 304. Within the producer subgraph 302, the first operation 204 processes input data and passes its output to the second and third operations 206, 208 via the first and second connections 212, 214, which correspond to first and second logical pipes, respectively. The second and third operations 206, 208, are each examples of a respective producer operation, and generate output data that is ultimately provided to the consumer subgraph 304. In other examples, a producer subgraph may have a single producer operation that provides a single output to a consumer subgraph such as the consumer subgraph 304.

The consumer subgraph 304 contains the fourth operation 210, which is an example of a consumer operation. The fourth operation 210 consumes the data produced by the producer subgraph 302, specifically the outputs from the second and third operations 206, 208, and performs further processing on this data.

The partitioning of the directed graph 202 into the producer subgraph 302 and the consumer subgraph 304 facilitates the process of chaining operations together. By identifying distinct producer and consumer subgraphs, a processing system can determine how to efficiently combine multiple operations into a single set of task data, such as a single Neural Engine Descriptor (NED), for execution on a neural engine architecture. The producer and consumer subgraphs may be base subgraphs generated based on graph data representing a directed graph of operations, such as the directed graph 202 or may be subgraphs comprising at least two base subgraphs which have e.g. been merged into a chain in a prior merging process. Each base subgraph comprises at least one operation of the original directed graph, and is associated with a respective subgraph space.

The relationship between the producer subgraph 302 and the consumer subgraph 304 is important for determining how to merge these subgraphs into a chain. The system analyzes the dimensional compatibility, transformation requirements, and hardware constraints to determine if the producer and consumer subgraphs can be efficiently combined. If compatible, the system can merge the subgraphs into a single chain, which can lead to more efficient execution on a processor, such as a neural engine, by reducing memory transfers and optimizing computational resources.

The system may also allow different angles of merging to merge the subgraphs into a chain, which can be beneficial. For example, to obtain a chain of merged subgraphs formed of the first to fourth operations 204-210, there can be different angles of merging, such as merging a subgraph of the first to third operations 204-208 with a subgraph of the fourth operation 210 or instead merging a subgraph of the first, second and fourth operations 204, 206, 210 with a subgraph of the third operation 208. However, merging a subgraph of the first, second and fourth operations 204, 206, 210 with a subgraph of the third operation 208 will be rejected as there is no clear consumer subgraph and producer subgraph.

Using multiple angles of merging allows the system to be able to handle a large variety of graph structures by enabling at least one angle in which a clear consumer subgraph and producer subgraph to be identified. The rest of the merging can then rely on the properties of the consumer-producer relationship to ensure correct data dependencies.

### Chaining Operational Subgraphs

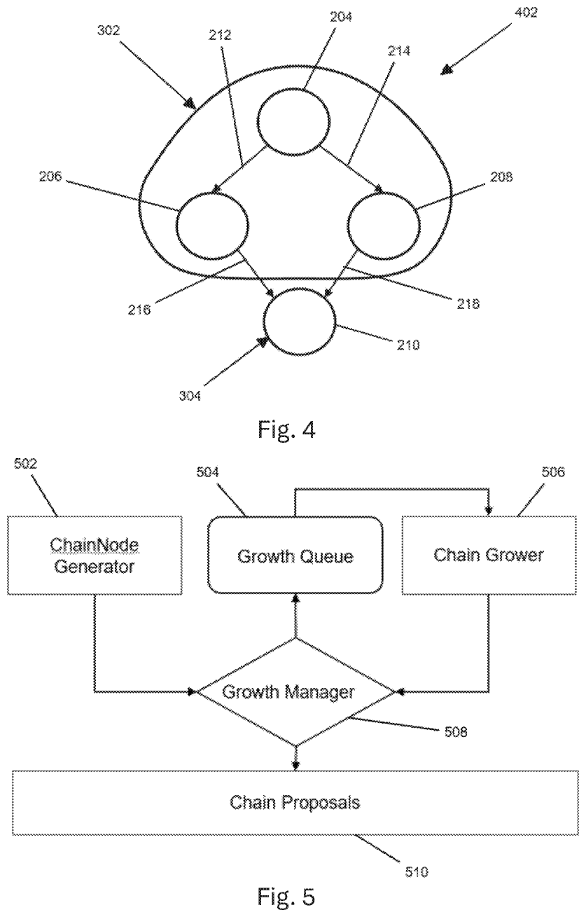

FIG. 4 illustrates features that relate to the producer and consumer subgraphs shown in FIG. 3. In particular, FIG. 4 shows how the producer subgraph 302 and consumer subgraph 304 can be combined to form a chain 402 of base subgraphs.

The chain 402 represents the result of a chaining process where the producer subgraph 302 and consumer subgraph 304 are merged into a single chain of base subgraphs. The chain may be executing more efficiently than executing each of the base subgraphs separately, for example by reducing memory transfers between operations and optimizing computational resource usage on a particular architecture.

Within the chain 402, the first connection 212 links the first operation 204 to the second operation 206, while the second connection 214 connects the first operation 204 to the second operation 206. The second operation 206 and the third operation 208 from the producer subgraph 302 are connected to the fourth operation 210 from the consumer subgraph 304 by the third and fourth connections 216, 218, respectively. These connections correspond to logical pipes that facilitate data transfer between operations within the producer and consumer subgraphs 302, 304.

By forming the chain 402, the system can generate task data, such as a single Neural Engine Descriptor (NED), that encompasses all four operations. This allows a processor, such as a neural engine, to execute the entire sequence of operations as a cohesive unit, maintaining data locality and reducing overhead associated with transferring intermediate results between separate operations. The chaining process considers factors such as dimensional compatibility between operations, transformation requirements, and hardware constraints to ensure that the resulting chain can be efficiently executed on the target neural engine architecture.

### System for Generating Chains of Neural Engine Operations

FIG. 5 illustrates a system for generating chains of operations for a neural engine. The system includes a base subgraph generator 502, a growth queue 504, a chain grower 506, a growth manager 508, and chain proposals 510.

The base subgraph generator 502 is configured to generate a plurality of base subgraphs that each comprise at least one operation of a directed graph of operations for which at least one chain of subgraphs is to be generated. A base subgraph may be referred to as a ChainNode. Each base subgraph represents a functionally correct realization of one or more operations that can be performed by a processor. For example, a given base subgraph may be the smallest functionally correct realization of a particular operation. Each base subgraph may begin with an input operation, end with an output operation and comprise at least one operation of the directed graph between the input and output operations.

A base subgraph may contain a single operation but some base subgraphs may contain a plurality of operations. For example, the base subgraph generator 502 may implement several features including identification of whether two operations must or should be chained together and bespoke kernel generation e.g. to generate a particular bespoke chain of operations, or operation, for example corresponding to a particular optimized realization of at least one operation. Each ChainNode is fully realized at the base subgraph generator 502 stage, with its subgraph space and constituent operation-specific local space transforms defined, so that each base subgraph is associated with a respective subgraph space. This includes all input operations (referred to herein as input reader, IR, operations) and output operations (referred to herein as output writer, OW, operations) within the ChainNode, and multiple operations if necessary to achieve the functionality of the subgraph. The set of base subgraphs generated by the base subgraph generator 502 for example constitutes the simplest and functionally correct realization of the whole directed graph upon which the base subgraphs are based. The approach herein aims to make chain growing operation-agnostic, and instead rely on architectural constraints and automatically-evaluated feasibility of transforms to propose new chains. The base subgraphs are for example the smallest functionally correct chains that are not intended to be searched at a finer granularity.

There may be more efficient realizations for a sequence of operations than the simple concatenation of realizations of each member of the sequence, for example for cases where the optimized sequence cannot be expressed in TOSA (Tensor Operator Set Architecture), but can be performed by the hardware. The feature of bespoke kernel generation performs an operation sequence pattern recognition and directly generates a chain proposal with the optimized realization. Each optimized kernel is generated as a single ChainNode, i.e. a single base subgraph. This means that the subsequent search granularity will not go finer than this optimized kernel, greatly reducing the search space. In some cases, each operation in the sequence can still form a ChainNode (i.e. base subgraph), and the optimized kernel is added as an additional chain proposal (i.e. as an additional base subgraph). This allows the solution space to be fully explored for the best chains, but also creates a much larger search space, leading to greater compilation time. In some cases, at least one bespoke subgraph may be generated manually (or via a different system than the bespoke kernel generator of the base subgraph generator 502). Whereas respective subgraphs are chained together in an acyclic manner, individual base subgraphs need not be internally acyclic. For example, a particular base subgraph, such as a bespoke base subgraph, may include at least one loop or other cyclic feature, e.g. provided that the base subgraph can be chained to other base subgraphs in a directed acyclic manner.

The base subgraph generator 502 also implements a feature to finalize transforms associated with respective base subgraph, e.g. to transform between an operation-specific local space of a given operation of a base subgraph and a subgraph space for the base subgraph. In addition, for each base subgraph, the base subgraph generator 502 generates a ChainNode realization that includes space transforms for respective operations of the ChainNode defined relative to the ChainNode's operation space, which may be referred to interchangeably herein as a subgraph space for that ChainNode.

For example, with newer architectures, it is more difficult for certain operations to properly define transforms at the base subgraph level, at which stage an execution space for execution of the task defined by the directed graph may not be defined. To address this, in examples herein, transformations to achieve functionality at the base subgraph level are defined before more complex chaining occurs. This for example involves generating a ChainNode realization that includes mapping a given base subgraph to multiple sections, i.e. operations, and setting up of IR & OW operations, so that appropriate transforms for IR & OW operations can be manually defined for more bespoke realizations. Realizations for particular base subgraphs can be merged together subsequently at the chain grower 506 stage. Every section, i.e. operation, and logical pipe's transform is defined relative to the ChainNode's operation space, i.e. relative to a subgraph space for the base subgraph corresponding to that ChainNode. This avoids a reliance on relative transformations between sections and pipes.

As part of realization, transform program data defining the respective transforms between the subgraph space for a particular base subgraph and the operation-specific local space of respective operations of the particular base subgraph may be generated for respective base subgraphs, to ensure that the respective base subgraphs are properly realizable for the given architecture. This may involve checking that various criteria are satisfied, such as whether there is sufficient space available for storing the transform program data and an availability of a sequence of instructions selected from a transform instruction set for a particular transform program represented by the transform program data. It may be required that all base subgraphs have legal realizations. If a given base subgraph does not meet this criterion, a manual realization for that base subgraph can be written using the bespoke kernels generator (not shown in FIG. 5). Every base subgraph should be self-contained in its functional correctness, and the subsequent chain grower 506 may be designed to work based on this requirement.

The growth queue 504 maintains a list of all the base subgraphs which can be chained together. The growth queue 504 serves as a thread-safe queue for chain operations and next nodes to be appended, allowing multiple threads of the chain grower 506 to performing chaining operations concurrently.

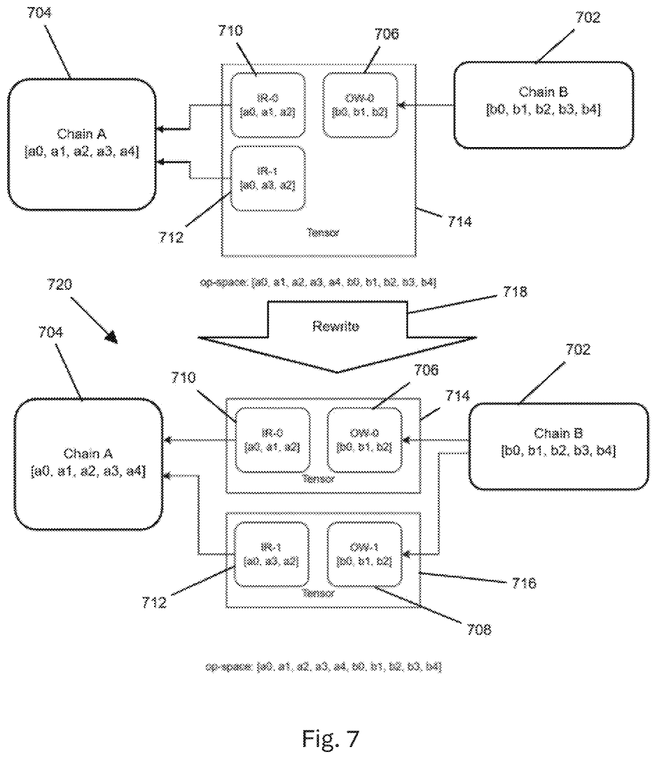

The chain grower 506 is responsible for chaining base subgraphs together to form larger chains. The chain grower 506 performs several operations including checks to verify that chains can be merged, an initial merge operation to combine chains, functional rewrites to ensure coherent transforms between chains, optimization rewrites to improve the efficiency of merged chains, and validity checks to verify that the resulting chains meet architectural constraints. The functional and optimization rewrites are discussed further below with reference to FIGS. 7 to 15.

The check to verify that chains can be merged is for example a pre-merge check of the two chains (which may be e.g. two subgraphs, a subgraph and an existing chain, or two existing chains), to implement constraints and ensure certain assumptions hold. Constraints that are checked may include that one chain is a consumer of another chain and/or to that both chains act on the same data, such as the same tensor slice of a given tensor.

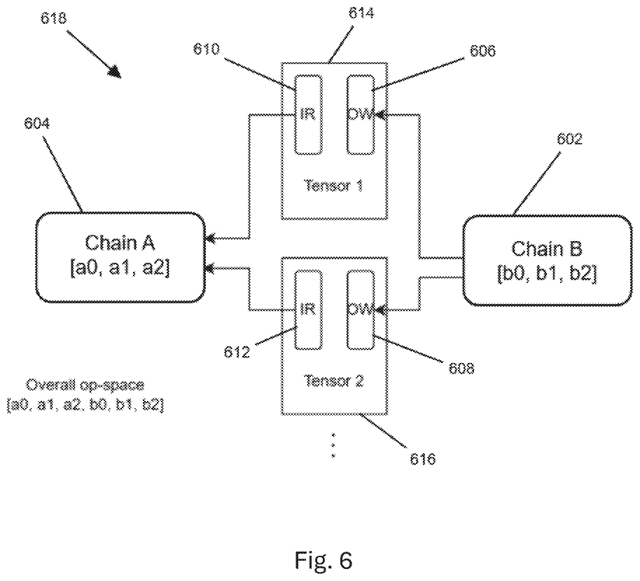

The aim of the initial merge operation, an example of which is shown in FIG. 6, is to perform the simplest possible functionally-correct merge of the two chains, ignoring architectural constraints and performance. This can be done by nesting the producer subgraph space of the producer subgraph inside the consumer subgraph space of the consumer subgraph. With the producer subgraph denoted as B and the consumer subgraph denoted as A, this preserves all OW-IR connections, all pipes and operations in B are iterated over by the number of dimensions in the consumer subgraph space of A, and the overall chain space of the merged chain (formed by merging A and B) can be denoted as [<op-space A>, <op-space B>], where op-space A is the consumer subgraph space and op-space B is the producer subgraph space. This means that in the resulting chain, all unresolved I/O (input/output) connections have the OW dimensions inwards with-respect-to the IR dimensions.

It is to be appreciated that the OW-IR connection is an abstract section which may be used to verify coherence of transforms at the interface between two chains. It tracks the production and consumption of a tensor, with a single OW and one or more IR involved. It has a virtual section space, i.e. operation-specific local space, of [<IR-dimensions>, <OW-dimensions>], which means that the entire tensor must be produced (recomputed) each time any IR tries to read any part of the tensor. This means (albeit in an inefficient way) that all IRs will always read correct data if this abstract section is managed by the processor just like any other section in its dependencies resolution.

In an example, if the initial merged is performed correctly, one complete traversal of op-space B occurs for every block issued in op-space A, where op-space A is the consumer subgraph space and op-space B is the producer subgraph space. This means that all intermediate tensors between B and A are always fully produced (recomputed) for each block increment in op-space A, and so sections (i.e. operations) in A (i.e. the consumer subgraph) execute on the same block of data as they would have in the original unmerged consumer subgraph.

Returning to the chain grower 506, the merging of two chains and ensuring coherent transforms and feasibility of realization is a complex task. In some examples, the chain grower 506 utilizes a merge and rewrite style process, starting with a simple initial merge of the two realizations within the growth queue 504, and then rewriting the (merged) realization progressively until no further changes are possible. When the rewrite process terminates, a final check of the legality of the realization view is performed. The merging of the chains for example ends when the growth queue 504 is emptied and nothing more is added.

The growth manager 508 coordinates the chaining process by managing the search direction and exploration angles for each possible chain. The growth manager 508 implements a bi-directional breadth-first traversal approach to explore potential chain combinations. Each possible chain may have multiple exploration angles, as discussed above with reference to FIG. 3, allowing at least one valid angle to try merging with. The growth manager 508 may also perform a check to evaluate whether chains have growth potential based on architectural constraints. Chain proposals 510 represent the output of the chaining system, containing valid chains that have been successfully merged and optimized. These chain proposals can then be used to generate task data defining a task to be executed by a processor.

The system operates by first generating base subgraphs through the base subgraph generator 502, placing them in the growth queue 504, processing them through the chain grower 506 under the coordination of the growth manager 508, and finally producing optimized chain proposals 510 that satisfy all architectural constraints of the target processor.

Fixing and optimization of a merged chain (such as one of the chain proposals) can then be performed via at least one rewrite as discussed further below with reference to FIGS. 7 to 15. A rewrite is for example self-contained and may be performed while maintain the functional correctness and/or non-self-dependency of the chain post-rewrite.

### Merging Producer and Consumer Subgraphs Through Chaining

FIG. 6 illustrates a block diagram showing a chaining process for merging a producer subgraph and a consumer subgraph, for example as performed during an initial merge process performed by the chain grower 506 of FIG. 5. The diagram depicts the various components and their relationships.

The producer subgraph 602 has a producer subgraph space with dimensions [b0, b1, b2]. The producer subgraph 602 includes a first output operation 606 and a second output operation 608. These output operations are responsible for outputting output data from the producer subgraph 602. For example, an output operation may be associated with writing an output to an external storage, which may be external to an execution unit for executing an operation that generated the output.

The consumer subgraph 604 has a consumer subgraph space with dimensions [a0, a1, a2]. The consumer subgraph 604 includes a first input operation 610 and a second input operation 612. These input operations receive input data for processing within the consumer subgraph 604. For example, an input operation may be associated with obtaining an input from an external storage, which may be external to an execution unit for executing an operation that generated the output, such as reading the input from the external storage. The external storage to which the data is written by the first and/or second output operations 606, 608 is the same as the external storage from which the data is obtained by the first and/or second input operations 610, 612, respectively, in this example. However, in other examples, the data may be transferred from the external storage to a further external storage before being obtained from the further external storage by the first and/or second input operations 610, 612.

The first output operation 606 of the producer subgraph 602 generates a first tensor 614, which is provided as input to the first input operation 610 of the consumer subgraph 604. Similarly, the second output operation 608 of the producer subgraph 602 generates a second tensor 616, which is provided as input to the second input operation 612 of the consumer subgraph 604.

When the producer subgraph 602 and consumer subgraph 604 are merged to form a chain 618, the chain space of the resulting chain has dimensions [a0, a1, a2, b0, b1, b2]. This merged chain space combines the dimensions of both the consumer subgraph 604 and the producer subgraph 602, with the consumer dimensions positioned as outer dimensions relative to the producer dimensions.

In the merging process, the tensors connecting the producer subgraph 602 and consumer subgraph 604 become internal to the chain 618. Specifically, the first tensor 614 and second tensor 616 that were previously external connections between separate subgraphs become internal data paths within the unified chain 618. This internalization allows for more efficient data handling.

The arrangement of dimensions in the chain 618, where consumer dimensions are positioned as outer dimensions relative to producer dimensions, ensures that for each block iterated over in the consumer subgraph dimensions, the producer subgraph completes a full traversal of its dimensions. This guarantees that all intermediate tensors between the producer subgraph 602 and consumer subgraph 604 are fully produced for each block increment in the consumer subgraph space, maintaining functional correctness in the merged chain 618.

### Merging Subgraphs with a Many-to-One Input/Output Relationship

FIG. 7 illustrates a method for merging a producer subgraph 702 and a consumer subgraph 704, involving a functional rewrite 718 of the chain. The producer subgraph 702 has a producer subgraph space with dimensions [b0, b1, b2, b3, b4], while the consumer subgraph 704 has space with dimensions [a0, a1, a2, a3, a4].

Prior to the functional rewrite 718, the producer subgraph 702 includes a first output operation 706. The first output operation 706 is associated with a first output subgraph space with dimensions [b0, b1, b2], and the second output operation 708 is associated with a second output subgraph space with dimensions [b0, b1, b2]. The consumer subgraph 704 includes a first input operation 710 associated with a first input subgraph space with dimensions [a0, a1, a2] and a second input operation 712 associated with a first input subgraph space with dimensions [a0, a3, a2].

Prior to merging the subgraphs, the system identifies that a production output of the first output operation 706 of the producer subgraph 702 is to be provided to both the first input operation 710 and the second input operation 712 of the consumer subgraph 704. This creates a many-to-one input/output relationship that requires special handling during the merging process. The production output is for example the data that is written to storage by the first output operation 706.

A rewrite process 718 is performed to handle this many-to-one relationship, which may be considered to form part of the merging of the producer and consume subgraphs 702, 704. During this rewrite process, the system generates a second output operation 708 as a duplicate of the first output operation 706, with a second output subgraph space with dimensions [b0, b1, b2]. The second output operation 708 is associated with a duplicate of the production output. The rewrite process 718 ensures that the production output is provided to the first input operation 710 and the duplicate of the production output is provided to the second input operation 712, by merging the producer and consumer subgraphs 702, 704.

Prior to the rewrite process 718, the production output transferred from the producer subgraph 702 to the consumer subgraph 704 is represented by a first tensor 714, which is output by the first output operation 706 and is input to the first and second input operations 710, 712. After the rewrite process 718, the first tensor 714 is output by the first output operation 706 and is input to the first input operation 710, and there is a second tensor 716 representing the duplicate of the production output, which is output by the second output operation 708 and input to the second input operation 712.

After the rewrite process 718, a chain 720 is formed with a combined chain space that includes dimensions from both the producer and consumer subgraphs 702, 704: [a0, a1, a2, a3, a4, b0, b1, b2, b3, b4]. This merged chain maintains the functional correctness of the original separate subgraphs while enabling more efficient execution by the neural engine.

The rewrite process 718 is particularly important when dealing with situations where a single output from one subgraph needs to be consumed by multiple inputs in another subgraph. Without this rewrite step, the merging process might result in incorrect data flow or computational results. By creating a duplicate of the output operation and its associated production output, which is for example written or otherwise output to storage by the output operation, this approach ensures that each input operation in the consumer subgraph receives the correct data while maintaining the overall computational integrity.

The duplication of output operations and their associated outputs enables a single producer to feed multiple consumers without breaking the chain. This approach preserves the performance benefits that come from chaining operations together while simultaneously supporting complex graph topologies with branch patterns. By creating duplicates of the output operation and its associated production output, the system can maintain direct connections between the producer and multiple consumer operations, ensuring data flows correctly to all required destinations while retaining the computational efficiency gained through merged execution chains.

For one-to-many relationships, a different approach may be taken. In these cases, multiple outputs of the producer subgraph are used as a single input to the consumer subgraph. In examples, chaining of the consumer subgraph to the producer subgraph may be forbidden and an attempt to perform such chaining may therefore fail. Such cases may involve identifying that a first and second production output of a further output operation of a further producer subgraph of the plurality of base subgraphs are to be provided to a further input operation of a further consumer subgraph of the plurality of base subgraphs and, in response, ceasing chaining of the further consumer subgraph to an end of the further producer subgraph.

### Merging Producer and Consumer Subgraphs to Achieve Production Coherence

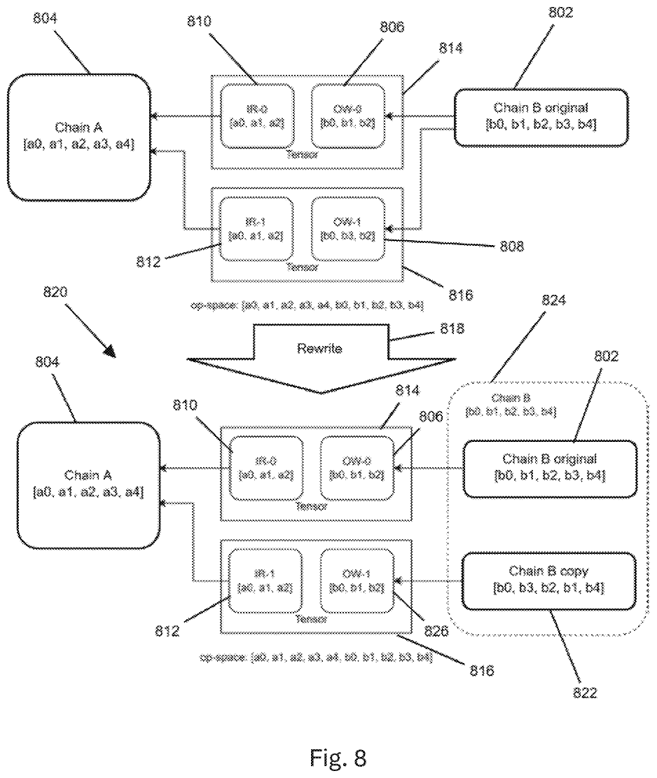

FIG. 8 illustrates a process for merging a producer subgraph 802 and a consumer subgraph 804. The Figure shows how a rewrite process 818 can be performed, e.g. as part of the merging of the producer and consumer subgraphs 802, 804, to handle situations where an output operation of a producer subgraph provides data to multiple input operations in a consumer subgraph.

The producer subgraph 802 of FIG. 8 has a producer subgraph space with dimensions [b0, b1, b2, b3, b4], while the consumer subgraph 804 has a consumer subgraph space with dimensions [a0, a1, a2, a3, a4]. Within the producer subgraph 802, there is a first output operation 806 and a second output operation 808, associated with first and second output operation spaces each having dimensions [b0, b1, b2]. The consumer subgraph 804 contains a first input operation 810 and a second input operation 812, associated with first and second input operation spaces each having dimensions [a0, a1, a2].

During the process of merging these subgraphs, it is identified that the first tensor 814 output by the first output operation 806 is to be provided to the first input operation 810, as an input to the consumer subgraph 804, and the second tensor 816 output by the second output operation 808 is to be provided to the second input operation 812, as a further input to the consumer subgraph 804. The system performs a rewrite 818 to ensure production coherence between the subgraphs. For example, merging of the producer and consumer subgraphs 802, 804 may comprise merging the consumer subgraph space and the producer subgraph space such that each dimension of the consumer subgraph space uniquely maps to a corresponding dimension of the producer subgraph space. In FIG. 8, the rewrite 818 is used to achieve a unique mapping between dimensions in the consumer subgraph 804, involved in the OW-IR interface, and dimensions in the producer subgraph 802. The rewrite 818 of this example involves duplication of base subgraphs, which may create base subgraphs that are unnecessary. Redundancy can be addressed at a later stage, for example by the optimization rewrites discussed further below.

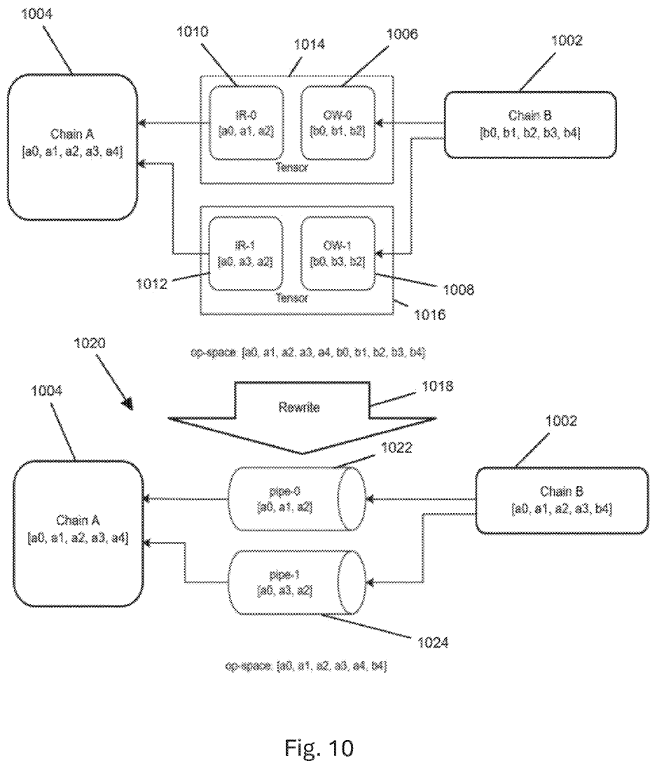

In the example of FIG. 8, a single dimension of the consumer subgraph space is mapped to multiple dimensions of the producer subgraph space prior to the rewrite 818 (as the second dimension, a1, of the first and second input operations 810, 812 is mapped to two different second dimensions, b1, b3, of the first and second output operations 806, 808). In this case, prior to merging, it is identified that a given dimension of the consumer subgraph 804 maps to a plurality of dimensions of the producer subgraph space. To achieve production coherence, the rewrite 818 involves generating a duplicate of the producer subgraph 822 and generating an updated producer subgraph 824 comprising the (original) producer subgraph 802 and the duplicate of the producer subgraph 822, which has a duplicate of the producer subgraph space. At least one dimension of the duplicate of the producer subgraph space is permutated such that the given dimension of the consumer subgraph space uniquely maps to a particular dimension of the updated producer subgraph 824. In this case, the dimensions of the duplicate of the producer subgraph 822 are rearranged from [b0, b1, b2, b3, b4] to [b0, b3, b2, b1, b4], so that the duplicate of the producer subgraph space is defined as [b0, b3, b2, b1, b4] after permutating dimensions of the duplicate of the producer subgraph space. This approach ensures that each dimension in the consumer subgraph 804 has a unique mapping to a dimension in the producer subgraph 802, to maintain functional correctness during the merge operation. The unique mapping facilitates the resolution of the OW-IR connections into logical pipes, for example as discussed with reference to FIG. 10.

After the rewrite, a chain 820 is formed with a chain space that includes dimensions from both the consumer subgraph 804 and the updated producer subgraph 824: [a0, a1, a2, a3, a4, b0, b1, b2, b3, b4]. Within this updated structure, the updated producer subgraph 824 contains the original output operations and their duplicates, including an updated second output operation 826, forming part of the duplicate of the producer subgraph 822 after dimensional permutation and having dimensions [b0, b1, b2] (where the second dimension of the duplicate of the producer subgraph space after dimensional permutation corresponds to the fourth dimension of the original producer subgraph space). A transform from the chain space to the updated producer subgraph space can then be defined.

The merging process ensures that the production output that is output, e.g. written to storage, by the first output operation 806 is provided to the first input operation 810, while the duplicate of the production output that is output by the updated second output operation 826 is provided to the second input operation 812. This approach maintains the correct data flow between the operations while enabling the subgraphs to be combined into a single, more efficient chain.

The duplication of output operations and their associated outputs enables a single producer to feed multiple consumers without breaking the chain. This approach maintains the performance benefits of chaining while supporting complex graph topologies where one operation's output needs to be provided to multiple subsequent operations. By creating duplicates of the output operation and its associated production output, the system can properly route data to multiple input operations in the consumer subgraph.

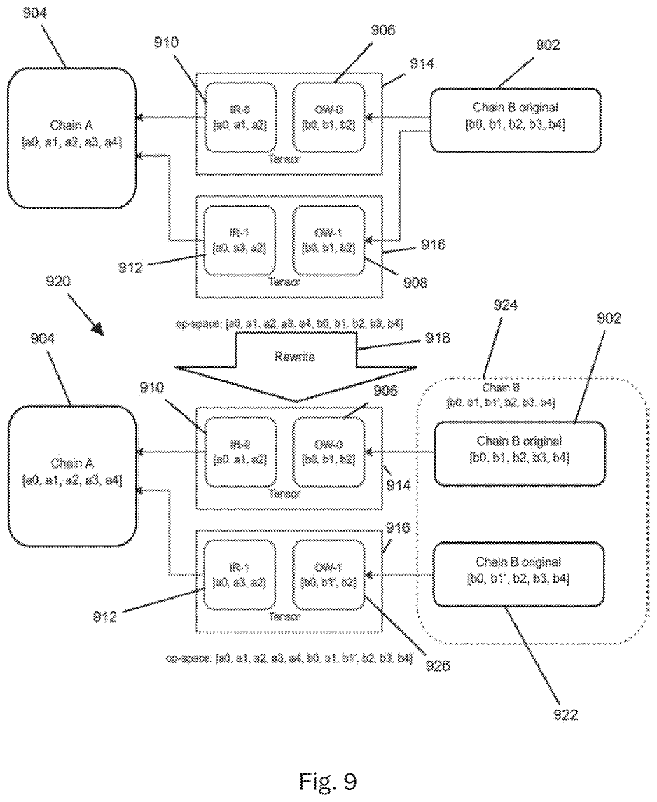

Merging Producer Subgraphs to Achieve Consumption Coherence FIG. 9 illustrates a process of merging a producer subgraph 902 with a consumer subgraph 904 to achieve consumption coherence. The Figure shows various components involved in this merging process and the transformations that occur.

The producer subgraph 902 has a producer subgraph space with dimensions [b0, b1, b2, b3, b4]. Within this producer subgraph 902, there is a first output operation 906 associated with a first output operation space having dimensions [b0, b1, b2] and a second output operation 908 associated with a second output operation space also having dimensions [b0, b1, b2]. These output operations output, e.g. by writing to storage, first and second tensors 914, 916 that are provided to the consumer subgraph 904.

The consumer subgraph 904 has a consumer subgraph space with dimensions [a0, a1, a2, a3, a4]. Within this consumer subgraph 904, there is a first input operation 910 associated with a first input operation space having dimensions [a0, a1, a2] and a second input operation 912 associated with a second output operation space having dimensions [a0, a3, a2]. The first input operation 910 and the second input operation 912 receive the first and second tensors 914, 916 from the producer subgraph 902, and for example involve reading the first and second tensors 914, 916 from the storage.

In FIG. 9, multiple consumer subgraph dimensions are mapped to a single producer subgraph dimension prior to performing a rewrite 918. In this example, prior to merging the producer subgraph 902 and the consumer subgraph 904, it is identified that a given dimension of the producer subgraph space maps to both a first dimension of the consumer subgraph space and a second dimension of the consumer subgraph space. In this case, a rewrite 918 is performed as part of the merging to address consumption coherence issues that arise when multiple dimensions in the consumer subgraph 904 map to a single dimension in the producer subgraph 902. In this case, the dimension a1 in the first input operation 910 and the dimension a3 in the second input operation 912 both map to the dimension b1 in the first and second output operations 906, 908 of the producer subgraph 902.

To resolve this coherence issue, a duplicate of the producer subgraph 922 is created, having a duplicate of the producer subgraph space, and an updated producer subgraph 924 is generated comprising the (original) producer subgraph 902 and the duplicate of the producer subgraph 922. The given dimension (b1) is replaced in the duplicate of the producer subgraph 922 with a further dimension (b1′) so that each dimension of the consumer subgraph space uniquely maps to a different respective dimension of the producer subgraph space. Hence, after the replacement, the duplicate of the producer subgraph 922 has dimensions [b0, b1′, b2, b3, b4], where b1′ is a duplicate of the dimension b1. The original producer subgraph 902 continues to provide its first tensor 914 to the first input operation 910, while the duplicate of the producer subgraph 922 provides a second tensor 916 to the second input operation 912.

The updated producer subgraph 924 now includes both the original producer subgraph 902 and the duplicate of the producer subgraph 922. The further dimension, b1′, is included within the updated producer subgraph space, consecutively with respect to the b1 (which was duplicated to generate b1′) to reduce dimensional re-ordering subsequently. The updated producer subgraph space can thus be denoted as [b0, b1, b1′, b2, b3, b4]. Within the duplicate of the producer subgraph 922, the second output operation is updated to become an updated second output operation 926 with dimensions [b0, b1′, b2].

After the rewrite 918, the producer subgraph 902 and consumer subgraph 904 are merged to form a chain 920. The chain 920 has a chain space with dimensions [a0, a1, a2, a3, a4, b0, b1, b1′, b2, b3, b4], which combines the dimensions from both the consumer subgraph 904 and the updated producer subgraph 924. In this merged chain 920, the first tensor 914 from the first output operation 906 is provided to the first input operation 910, and the second tensor 916 from the updated second output operation 926 is provided to the second input operation 912. A transform from the chain space to the updated producer subgraph space can then be defined.

This merging process ensures that when a production output needs to be provided to multiple input operations in the consumer subgraph 904, appropriate duplication of the output operation and its associated output can be performed to maintain the correct data flow and dimensional mapping between the producer and consumer subgraphs 902, 904.

The duplication of output operations and their associated outputs enables a single producer to feed multiple consumers without breaking the chain. When a production output needs to be provided to multiple input operations, the system identifies this requirement and generates a duplicate of the output operation along with a duplicate of the production output. This approach maintains the performance benefits of chaining while supporting complex graph topologies where data from one operation needs to flow to multiple destination operations.

### Formation of Logical Pipes

FIG. 10 illustrates a block diagram of a chaining process involving a producer subgraph 1002 and a consumer subgraph 1004. The Figure depicts the process of forming a logical pipe during chaining of the producer and consumer subgraphs 1002, 1004. The process of FIG. 10 may be performed after at least one functional rewrite, such as the functional rewrites of FIGS. 7, 8 and/or 9.

The producer subgraph 1002 initially has a producer subgraph space with dimensions [b0, b1, b2, b3, b4]. This subgraph includes a first output operation 1006 associated with a first output operation space with dimensions [b0, b1, b2] and a second output operation 1008 associated with a second output operation space with dimensions [b0, b3, b2]. These output operations are responsible for outputting first and second tensors 1014, 1016 that will be consumed by the consumer subgraph 1004.

The consumer subgraph 1004 has a consumer subgraph space with dimensions [a0, a1, a2, a3, a4]. Within this subgraph, there is a first input operation 1010 associated with a first input operation space with dimensions [a0, a1, a2] and a second input operation 1012 associated with a second output operation space with dimensions [a0, a3, a2]. These input operations are designed to obtain the tensors 1014, 1016 produced by the producer subgraph 1002.

In FIG. 10, each dimension in the consumer subgraph space involved in the OW-IR interface has a unique mapping to a dimension in the producer subgraph space. Now, the two subgraphs can be merged into a single chain, converting every OW-IR connection into a pipe connect, i.e. a logical pipe, with the appropriate transforms. This is shown in FIG. 10 as a rewrite 1018, which also transforms the dimensions of the producer subgraph space from [b0, b1, b2, b3, b4] to [a0, a1, a2, a3, a4], matching the dimensions of the consumer subgraph space, to align the subgraphs.

After the rewrite 1018, there is a chain 1020 in which first and second OW-IR connections (corresponding to the outputting and inputting of first and second tensors 1014, 1016) are replaced by first and second logical pipes 1022, 1024, respectively. The first logical pipe 1022 has dimensions [a0, a1, a2], and the second logical pipe 1024 has dimensions [a0, a3, a2]. A logical pipe may be a more efficient way of transferring data between connected operations in a directed graph than other approaches. This amounts to mapping the first output operation 1006 of the producer subgraph 1002 and the first input operation 1010 of the consumer subgraph 1004 from the chain 1020 to the first logical pipe 1022 for the producer subgraph 1002 to output data to and for the consumer subgraph 1004 to receive data from (and similarly for the second logical pipe 1024).

If at least one of the tensors 1014, 1016 is consumed outside the producer and consumer subgraphs 1002, 1004, the OW to write the respective tensor to storage may be preserved. If the operation-specific local space of the input and/or output operations has more dimensions than by the pipe descriptor for a given logical pipe, then solely the innermost dimensions may be mapped to the pipe transform, and block constraints for the unmapped dimensions to have a block size of 1 may be added.

The merging process effectively combines the producer and consumer subgraphs into a unified chain using logical pipes, allowing for more efficient execution by eliminating the need for intermediate storage of tensors between the subgraphs, e.g. in storage external to a hardware accelerator for executing a task comprising the subgraphs. This approach optimizes the overall computation by reducing memory traffic and enabling better utilization of internal buffers or other storage of the hardware accelerator.

### Chain Rewriting for Consolidation

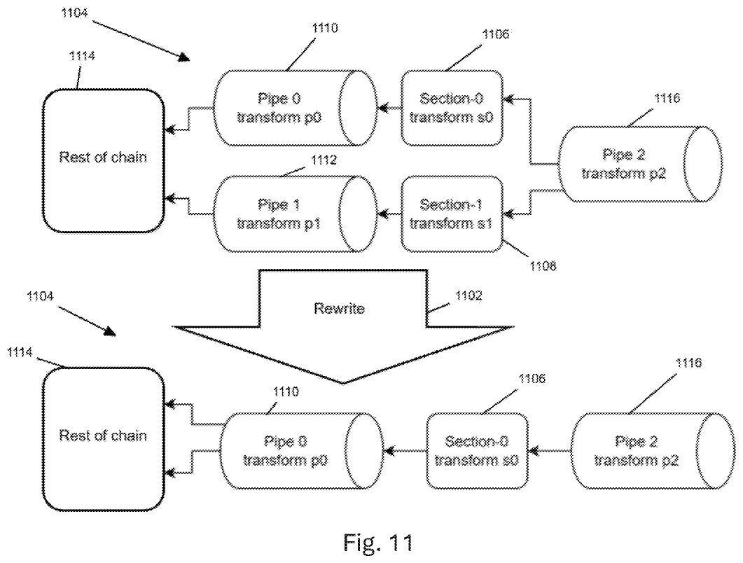

FIG. 11 illustrates a rewriting 1102 a chain 1104 of base subgraphs to consolidate at least two duplicate portion of the chain 1104. In the functional rewrites discussed above, various additional operations and/or subgraphs may be added to maintain functional correctness in the chain merging process. After generation of the chain, and after the functional rewrite(s), this is the opportunity to re-examine the chain, remove redundancies and optimize the chain. FIG. 11 shows an example of a rewrite 1102 but various other rewrites may be performed instead or as well, to further optimize the chain 1104.

The chain 1104 includes a first operation 1106 and a second operation 1108. The first operation 1106 and the second operation 1108 may represent computational operations to be performed on data flowing through the neural network processing system.

The chain 1104 further includes a first logical pipe 1110, a second logical pipe 1112 and a third logical pipe 1116, which facilitate data transfer between operations. The third logical pipe 1116 provides data to the first and second operations 1106, 1108. The output of the first and second operations 1106, 1108 are provided to the first and second logical pipes 1110, 1112, which provide the data therein to the rest of the chain 1114. The rest of the chain 1114 represents additional operations that may follow the first and second input operations.

In FIG. 11, the first and second logical pipes 1110, 1112 are the same as each other, and the first operation 1106 and the second operation 1108 are the same as each other. In this case, the rewrite 1102 consolidates the first logical pipe 1110 with the second logical pipe 1112 since they are the same, and e.g. share the same characteristics. Additionally, the rewrite 1102 consolidates the second input operation 1108 with the first input operation 1106 as they are the same, and e.g. perform identical functions. This consolidation creates a more efficient chain structure. In this case, the consolidation amounts to removing the duplicate portions of the chain, i.e. the second operation 1108 and second logical pipe 1112, which are duplicates of the first operation 1106 and first logical pipe 1110 respectively.

By consolidating identical operations and/or logical pipes, the neural network processing system can reduce redundancy and improve processing efficiency.

The consolidation process enables the neural network processing system to optimize computational resources by eliminating duplicate operations and data paths. This optimization is particularly beneficial when performing complex processing, such as processing of complex neural networks, with numerous identical or similar operations that can be combined to reduce the overall computational load.

### Chain Rewriting to Remove Unused Logical Pipes

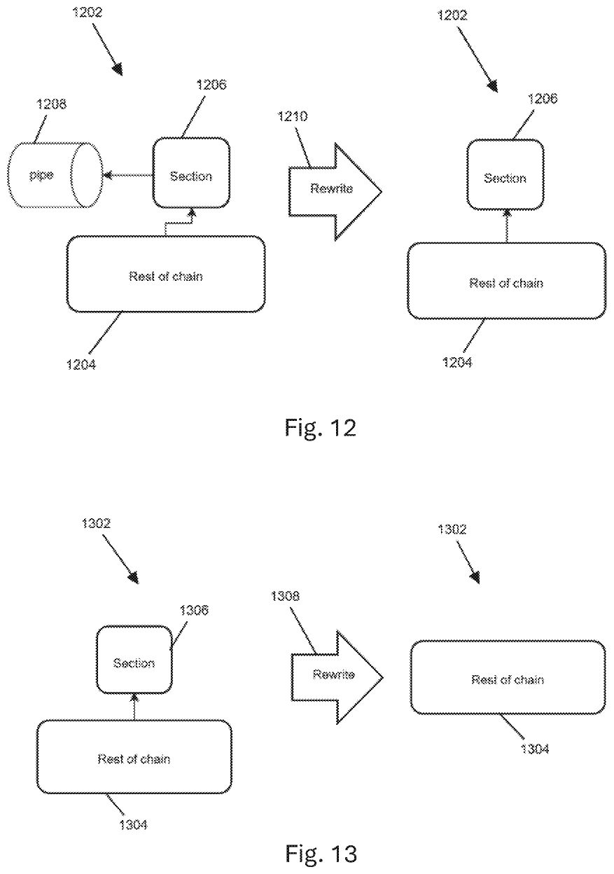

FIG. 12 illustrates adjusting, e.g. rewriting 1210, a chain 1202 of base subgraphs to remove at least one redundant aspect. In FIG. 11, the redundant aspect is an unconsumed output of an output operation that is unconsumed within the chain 1202, which in this case corresponds to an unused logical pipe 1208. The rewrite 1210 may be performed after the functional rewrite(s) discussed above.

The chain 1202 comprises an operation 1206 that receives data from the rest of the chain 1204 and outputs data to the logical pipe 1208. The logical pipe 1208 is not consumed within the chain 1202 itself. The rewrite 1210 represents a transformation operation that can modify the structure of the chain 1202 to optimize processing efficiency. Through the rewrite 1210, redundant aspects of the chain 1202 can be identified and removed. In this example, the logical pipe 1208 is identified as redundant as it is associated with an output that is not consumed within the chain 1202. By removing such redundant elements, the processing efficiency of the neural network can be improved while maintaining functional correctness.

### Chain Rewriting to Remove Non-Output Operations

FIG. 13 illustrates a further example of adjusting, e.g. rewriting 1308, a chain 1302 of base subgraphs to remove at least one redundant aspect. The rewrite 1308 may be performed after the functional rewrite(s) discussed above.

The chain 1302 comprises an operation 1306 that receives data from the rest of the chain 1304. During execution of a rewriting process, the operation 1306 is analyzed to determine if it can be removed from the chain 1302. The operation 1306 may be identified as redundant if it does not generate an output for storage. Specifically, the operation 1306 may be a non-output operation positioned at a branch end of a branch of the chain 1302. In such cases, the operation 1306 does not contribute to the final output of the chain and can be safely removed without affecting the functional correctness of the chain.

The rewriting process produces a rewritten version of the chain 1302, which maintains the functionality of the original chain 1302 but with improved efficiency through the removal of the redundant operation 1306. The rewritten version of the chain 1302 includes the rest of the chain 1304 portion of the original chain 1302, but omits the redundant operation 1306, resulting in a more streamlined chain structure.

The rewriting process shown in FIG. 13 may be part of a larger chain optimization framework that aims to improve the efficiency of execution of a task defined by a directed graph of operations. By identifying and removing redundant operations such as the operation 1306, the rewriting process can reduce computational overhead and improve overall performance of the task execution. It is to be appreciated that an output operation (e.g. an OW section) may be excluded from the removal of redundant operations, e.g. defined as operations that do not provide an output to a logical pipe.

### Dimensional Reduction Through Chain Space Rewriting

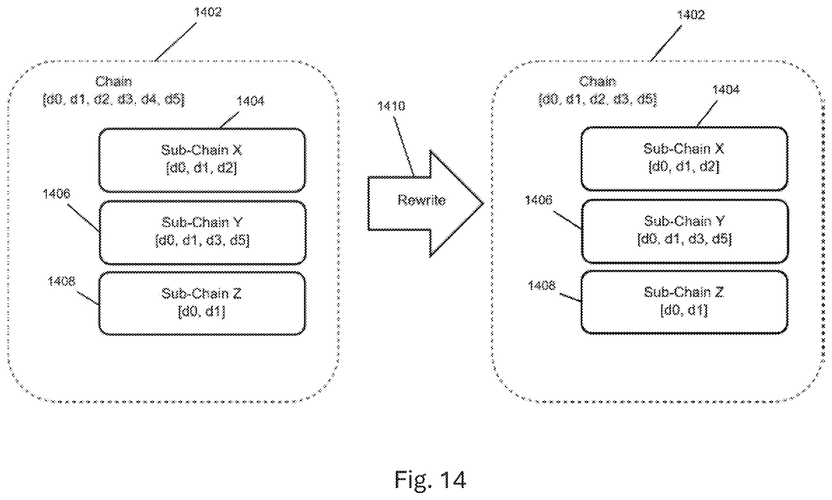

FIG. 14 illustrates a block diagram of a rewrite operation 1410 performed on a chain 1402. The chain 1402 initially has a chain space with dimensions [d0, d1, d2, d3, d4, d5]. The rewrite operation 1410 removes dimension d4 from the chain space, resulting in a modified version of the chain 1402 with dimensions [d0, d1, d2, d3, d5]. This rewrite operation removes a redundant aspect from the chain space, specifically dimension d4, which is unused by the base subgraphs of the chain.

The chain 1402 includes a first sub-chain 1404, a second sub-chain 1406, and a third sub-chain 1408. Each sub-chain operates within its own specific sub-chain space that may be a subset of the overall chain space. The first sub-chain 1404 has a first sub-chain space with dimensions [d0, d1, d2], utilizing only three of the original six dimensions. The second sub-chain 1406 has a second sub-chain space with dimensions [do, d1, d3, d5], utilizing four dimensions but not using dimension d4. The third sub-chain 1408 has a third sub-chain space with dimensions [d0, d1], utilizing only two dimensions.

By examining the dimensional spaces of each sub-chain, it becomes apparent that dimension d4 is not utilized by any of the sub-chains 1404, 1406, and 1408. The rewrite operation 1410 identifies this unused dimension d4 and removes it from the chain space, optimizing the chain 1402 by eliminating unnecessary complexity. This optimization simplifies the chain representation and potentially improves computational efficiency by reducing the dimensionality of the chain space to be processed.

The rewrite operation 1410 maintains the functional equivalence of the chain 1402 while reducing its dimensional complexity. After the rewrite operation 1410, the modified version of the chain 1402 maintains all the necessary dimensions required by its constituent sub-chains, ensuring that all computational requirements are preserved. The dimensions do and d1 are common to all sub-chains, dimension d2 is specific to the first sub-chain 1404, and dimensions d3 and d5 are utilized by the second sub-chain 1406.

The chain space may also or instead be adjusting to combine at least two dimensions of the chain space that are non-orthogonal to each other in the chain space. Orthogonal dimensions are for example dimensions that exist as separate iteration dimensions in the chain space of the chain. The starting point to deduce orthogonality is to examine every operation in a chain. For each operation-specific local space for the operations in a given chain, such as a consumer subgraph space for a consumer subgraph, a producer subgraph space for a producer subgraph and so forth, all chain space dimensions that are projected onto the operation-specific local space are considered to be orthogonal to each other. Two dimensions can be merged directly in the chain space if the dimensions are not orthogonal to each other in the chain space and if the dimensions have the same task boundaries.

Combining of non-orthogonal dimensions of the chain space can also reduce or avoid unnecessary recomputation, which can lead to significant improvements in computational efficiency. For example, given two Reduction operations whose outputs feed into an ADD operation, the rest of the chaining process described herein creates a chain space with 2 reduction dimensions, each inherited from the two Reduction operations. This means that one of the Reduction operations will be recomputed in its reduction dimension for each iteration in the other Reduction operation's reduction dimension. The identifying of the two reduction dimensions as being non-orthogonal and merging them allows a single dimension in the chain space to drive the reduction in both Reduction operations, avoiding the recomputation.

### Generation of Logical Forwarding Pipe

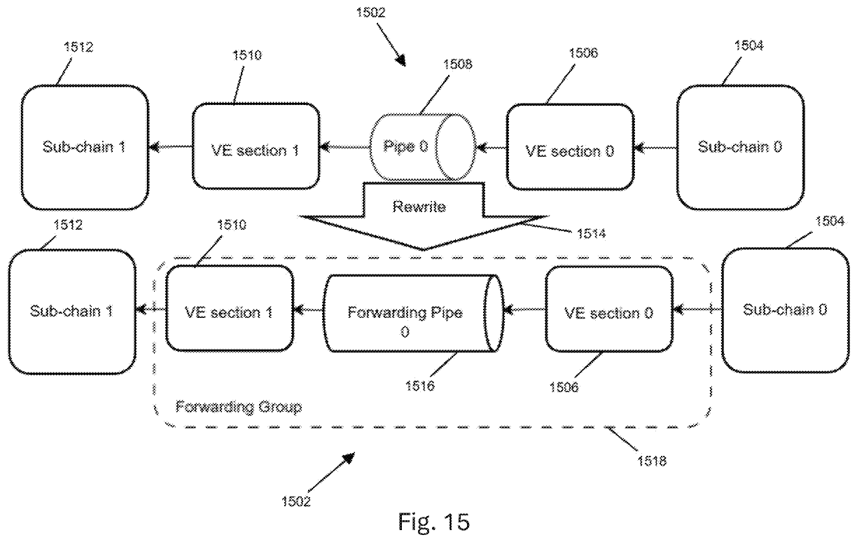

FIG. 15 shows a block diagram illustrating a chain 1502 that includes a first sub-chain 1504 and a second sub-chain 1512. The chain 1502 represents a sequence of operations to be performed to execute a task.

The first sub-chain 1504 includes a first vector engine operation 1506 and a logical pipe 1508. The first vector engine operation 1506 is configured to perform vector processing operations, such as element-wise arithmetic operations, activation functions, or other vector-based computations. The logical pipe 1508 is connected to the output of the first vector engine operation 1506 and serves as a data pathway for transferring processed data.

The second sub-chain 1512 includes a second vector engine operation 1510. The second vector engine operation 1510 is also configured to perform vector processing operations, and is configured to receive the data from the logical pipe 1508. Both the first vector engine operation 1506 and the second vector engine operation 1510 are mapped to the same execution unit of the processor, specifically the vector engine, for executing the task (but need not be in other examples).

A rewrite 1514 is applied to the chain 1502. The rewrite 1514 is a transformation operation that modifies the structure or configuration of the chain to optimize performance or enable certain functionality. In this case, the rewrite 1514 transforms the logical pipe 1508 into a logical forwarding pipe 1516. This amounts to tagging a connection (in this case the logical forwarding pipe 1516) between the first and second sub-chains 1504, 1512 (which correspond to producer and consumer subgraphs, respectively) as associated with a plurality of sequential operations that are to be performed by the vector engine.

The logical forwarding pipe 1516 may provide a more efficient data transfer mechanism between the first vector engine operation 1506 and the second vector engine operation 1510. Unlike standard logical pipes, the logical forwarding pipe 1516 allows for direct data forwarding between consecutive vector engine operations, reducing data movement overhead and improving processing efficiency.

Additionally, the first vector engine operation 1506 and the second vector engine operation 1510 are grouped together into a logical forwarding group 1518. The logical forwarding group 1518 represents a collection of vector engine operations that can utilize the forwarding pipe mechanism for data transfer. This grouping allows a processor, such as a neural engine, to treat the operations within the group as a unified entity for scheduling and execution purposes, potentially enabling further optimizations. The operations within a forwarding group can be mapped to the same execution unit of a processor, e.g. the vector engine in this case, leveraging spatial locality in hardware to reduce data movement between different processor components.

This approach may involve generating forwarding pipe configuration data indicating that the logical pipe 1508 is a logical forwarding pipe for forwarding data generated by a set of operations of the chain of base subgraphs that are to be grouped together for execution (in this case, the forwarding group 1518), where the set of operations comprise at least one operation of the producer subgraph (in this case, the first vector engine operation 1508). The forwarding pipe configuration data may be used by the processor to facilitate scheduling and execution of the logical forwarding group 1518.

The arrangement shown in FIG. 15 demonstrates how the chain structure can be optimized through rewrites to take advantage of architectural features such as logical forwarding pipes. This optimization can lead to more efficient execution of neural network operations by reducing data movement overhead between consecutive vector engine operations. Although the example of FIG. 15 illustrates the concept of logical forwarding pipes and groups in the context of vector engine operations, it is to be appreciated that these concepts may be applied equally to other operations.

### Computational Graph Optimization Through Local Space Equivalence

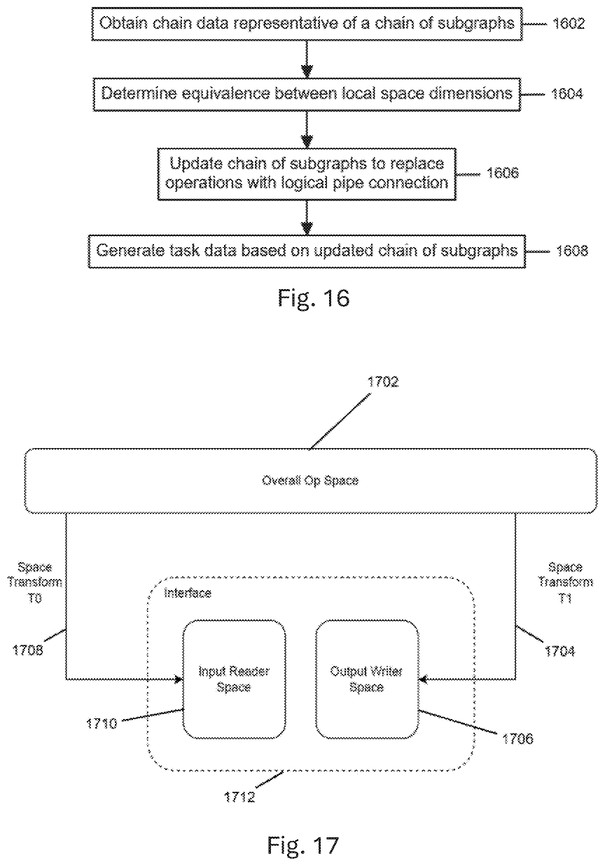

FIG. 16 illustrates a method for optimizing computational graph operations by establishing equivalences between local space dimensions and using the equivalences to form logical pipe connections. Methods in accordance with FIG. 16 may be used in the formation of logical pipes as described in other examples herein, such as the example shown in FIG. 10.

The method of FIG. 16 begins at block 1602 with obtaining chain data representative of a chain of subgraphs. This chain data represents at least part of a directed graph of operations and is associated with a chain space. The chain of subgraphs includes a first subgraph, such as the producer subgraph 1002 of FIG. 10, an output operation to obtain output data from the first subgraph, such as the first or second output operations 1006, 1008 of FIG. 10, an input operation to obtain the output data from the output operation, such as the first or second input operations 1010, 1012 of FIG. 10, and a second subgraph, such as the consumer subgraph 1004 of FIG. 10, to obtain the output data from the input operation. The output operation is associated with a first local space, while the input operation is associated with a second local space.

At block 1604 of FIG. 16, based on the chain data, an equivalence is determined between at least one first local space dimension of the first local space and a corresponding at least one second local space dimension of the second local space. The first local space dimension is to be iterated over to execute the output operation, and the second local space dimension is to be iterated over to execute the input operation. This equivalence determination may involve analyzing space transformations that map between the chain space and the respective local spaces, which may be referred to as respective transforms and are discussed below with reference to FIGS. 17 to 21. At block 1606, based on the determined equivalence, the chain of subgraphs is updated to replace at least a combination of the output operation and the input operation with a connection corresponding to a logical pipe. This logical pipe directly connects the first subgraph to the second subgraph. The update can eliminate the need for intermediate memory operations, as data can flow directly between the subgraphs through the logical pipe rather than being written to and read from memory.

Finally, at block 1608, based on the updated chain of subgraphs, task data is generated that describes a task to be executed. This task data takes the form of a further directed graph of operations that is representative of at least the part of the directed graph of operations from which the chain data was derived. The further directed graph incorporates the optimizations made by replacing the output and input operations with the logical pipe connection, resulting in a more efficient computational structure that can be executed with reduced memory operations.

The method shown in FIG. 16 can be particularly beneficial for generating task data for tasks to be executed in hardware processors designed for processing of computational graphs, as the updated chain of subgraphs can be executed with reduced memory bandwidth requirements and latency by eliminating unnecessary memory read and write operations between connected subgraphs. The resulting optimized computational structure can execute more efficiently on such hardware.

The optimization through direct data flow may provide substantial computational efficiency improvements. By replacing the output and input operations with a logical pipe connection, intermediate memory operations that would otherwise require writing data to memory from the first subgraph and then reading it back for the second subgraph can be eliminated. This direct connection can reduce processing latency and decrease memory bandwidth consumption, allowing for faster execution of complex computational tasks.

Linking subgraphs of operations of a directed graph of operations by logical pipes can simplify orchestration of operations amongst execution units of a processor to execute the task. For example, the operations and their relationship to each other can be determined by their logical pipe usage, simplifying the control of an offload processor (e.g. a neural engine or other hardware accelerator) to execute the task. This approach can therefore provide a more straightforward control mechanism for offload processors.

The detection of space dimension equivalence enables sophisticated optimization across differently structured subgraphs. When it is identified that dimension(s) in the first local space correspond to dimension(s) in the second local space, a direct connection between the first and second subgraphs can be established despite differences in how each subgraph organizes its data. This capability extends optimization opportunities beyond simple cases, allowing for performance improvements in complex computational graphs with varied space transformations.

Determining an equivalence between first and second local space dimensions of the first and second local spaces can result in a more streamlined computational structure, while preserving all functional relationships. By generating an updated directed graph based on the optimized chain of subgraphs, redundant operations are eliminated while maintaining the original computational intent. The resulting computational representation requires fewer resources to execute, enabling more complex algorithms to run within the same hardware constraints.

### Space Transformations for Subgraph Connection Resolution

FIG. 17 illustrates an arrangement for resolving connections between subgraphs in a directed graph of operations. As shown in FIG. 17, the arrangement includes a chain space 1702, which represents an overall operation space associated with a chain of subgraphs and is denoted as an “Overall Op Space” in the Figure. For example, the chain space 1702 may be formed by concatenating respective local spaces associated with each subgraph (e.g. as described with reference to FIG. 6) and, in some cases, performing at least one rewrite process, such as at least one of the rewrite processes 718, 818, 918 described with reference to FIGS. 7 to 9. For example, the chain space 1702 may correspond to a superset of respective local spaces for operations and/or subgraphs within the chain. Local spaces may be disjoint from each other or at least partially overlap each other (or a local space may be disjoint from a first set of local spaces but at least partially overlap at least some of a second set of local spaces).

The arrangement of FIG. 17 includes a first transform 1704 and a second transform 1708, which transform from the chain space 1702 to different local spaces, respectively. The first and second transforms 1704, 1708 are denoted as “Space Transform T1” and “Space Transform T0” respectively in FIG. 17. The first transform 1704 maps dimensions from the chain space 1702 to a first local space 1706, which in this example is an output writer (OW) space. The first local space 1706 is associated with an output operation (in this case an OW operation) to obtain output data from a first subgraph, such as the first or second output operations 1006, 1008 to obtain output data from the producer subgraph 1002 of FIG. 10. The output operation is for example for writing an output (in this case, the output data) to external storage, which is e.g. external to a processor configured to execute the chain. Similarly, the second transform 1708 maps dimensions from the chain space 1702 to a second local space 1710, which in this example is an input reader (IR) space. The second local space 1710 is associated with an input operation (in this case an IR operation) to obtain output data from a first subgraph, such as the first or second input operations 1010, 1012, to obtain the output data from the OW operation, to input to the second subgraph, such as the consumer subgraph 1004 of FIG. 10. The input operation is for example for obtaining, e.g. reading, an input (such as the output data) from the external storage and/or from further external storage, external to the processor configured to execute the chain.

The first local space 1706 and the second local space 1710 may be considered to form an interface 1712 between the first and second subgraphs. The interface 1712 represents the connection between the output operation from the first subgraph and the input operation to the second subgraph.

When determining an equivalence between dimensions in the first local space 1706 and the second local space 1710, dimensions to be iterated over that correspond to each other can be identified. This equivalence allows the combination of the output and input operations to be replaced with a logical pipe that directly connects the first subgraph to the second subgraph, eliminating the need to write to and read from memory. This enables blocks of data that would have originally been written out to memory by the OW operation to be directly stored into the logical pipe, to be transferred to the second subgraph without using the IR operation to read the blocks from the memory.

In examples, determining an equivalence between dimensions in the first and second local spaces 1706, 1710 comprises determining that the equivalence is between the first and second local spaces 1706, 1710 (in other words, that the first and second local spaces 1706, 1710 are equivalent to each other). For example, if the first local space 1706 is to be iterated over in first blocks to execute the output operation (e.g. by writing the output data in first blocks) and the second local space 1710 is to be iterated over in second blocks to execute the input operation (e.g. by reading the output data in second blocks), each block iteration over a respective first block in the first local space 1706 may correspond to a respective iteration over a corresponding second block in the second local space 1710. For example, a first block size of the first blocks in the first local space 1706 may be the same as a second block size of the second blocks in the second local space 1710.

If the first and second transforms 1704, 1708 from the chain space 1702 to the first and second local spaces 1706, 1710 are the same as each other and the first and second local spaces 1706, 1710 are equivalent to each other, then the interface 1712 can be replaced by a logical pipe directly.

However, the first and second transforms 1704, 1708 from the chain space 1702 to the first and second local spaces 1706, 1710 may be different from each other. This means that dimensions in the chain space 1702 may be mapped differently to the first local space 1706 and the second local space 1710. In other words, at least one dimension in the first local space 1706 and its corresponding dimension in the second local space 1710 may be derived from different dimensions in the overall chain space 1702. In this case, and despite these different transforms, the equivalence between dimensions at the interface 1712 can allow these different dimensions in the chain space 1702 to be derived from e.g. a single dimension. This enables the interface 1712 to be resolved into a logical pipe to transfer data from the first subgraph to the second subgraph, e.g. without writing the data out to storage external to a processor configured to execute the chain.

The first and second transforms 1704, 1708 may be referred to herein as space transformations. A space transformation may be represented by a plurality of transforms that are applied in sequence to an input (e.g. a vector or matrix) in a source space (such as the chain space 1702), sequentially transforming the input to a projection into a destination space (such as the first or second local spaces 1706, 1710). The plurality of transforms may be referred to as a transform stack. This is discussed further below with reference to FIGS. 22 to 24.

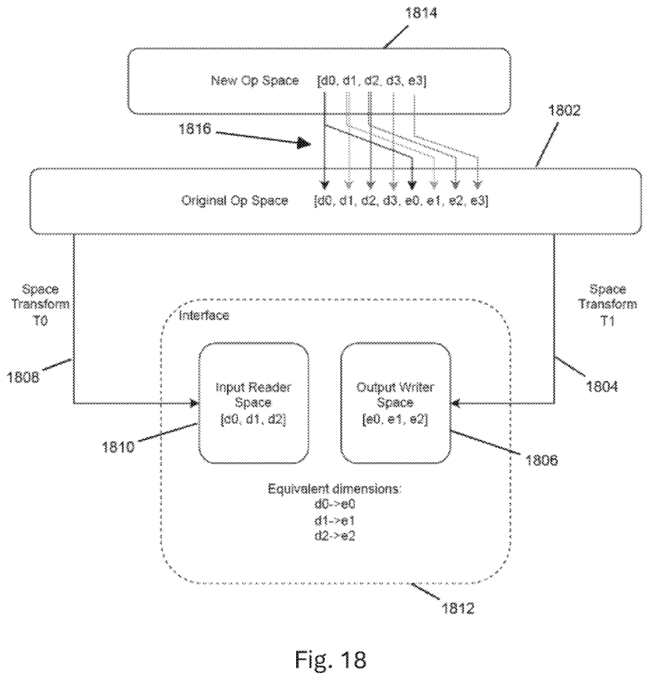

At least one transform (e.g. a plurality of transforms) representing a space transformation may comprise affine transform(s), which are linear transforms that may be represented by matrices, and/or non-affine transform(s), which are non-linear operations such as clipping, integer division, negation, remainder or dimensional splitting operations. When the transforms from chain space to local spaces associated with respective operations of the chain are affine and permutative, the equivalence between respective dimensions of two local spaces can be determined through direct projection of dimensions, as discussed further with reference to FIG. 18.

For more complex cases involving non-affine transformations or non-permutative affine transformations, techniques such as augmenting the space transforms to preserve source space information (such as information regarding the chain space 1702) may be employed, allowing dimensions to be properly mapped and equivalence to be established. This may involve expanding the transforms to include copies of the chain space 1702, which may be referred to as the original operation space, ensuring dimensional information is preserved and recoverable.

After determining the equivalence and updating the chain of subgraphs to replace the input and output operations with the logical pipe, task data that describes a task to be executed can be generated, as explained with reference to FIG. 16. This task data is in the form of a further directed graph of operations that represents at least part of the original directed graph of operations, but with the logical pipe connecting the first subgraph to the second subgraph.

This approach can accommodate complex dimensional mappings between subgraphs, enabling interface equivalence detection even when the original transforms from the chain space 1702 to the respective local spaces differ. This flexibility allows the system to identify opportunities for logical-pipe-based optimization across a wider range of computational scenarios, including those with non-identical space transformations. The ability to establish equivalence despite different transform characteristics expands the potential for optimization beyond simple cases, making the approach applicable to diverse and complex computational graphs.

FIG. 18 illustrates a further arrangement for resolving connections between subgraphs in a directed graph of operations. FIG. 18 shows a chain space 1802, which in FIG. 18 is denoted as an “Original Op Space”, with dimensions [d0, d1, d2, d3, e0, e1, e2, e3]. The chain space 1802 represents the overall operation space of a chain of subgraphs to be executed in performing a task represented by a directed graph of operations. The chain need not represent the entirety of the directed graph of operations; execution of the task may comprise executing the chain on its own or in combination with at least one further chain of subgraphs representing a different portion of the directed graph of operations than the chain.

The chain space 1802 is transformable to local spaces associated with respective operations of the chain via respective transforms. In FIG. 18, the chain space 1802 can be transformed to first and second local spaces 1806, 1810 via a first transform 1804 (denoted “Space Transform T1” in FIG. 18) and a second transform 1808 (denoted “Space Transform T0” in FIG. 18), respectively. The first local space 1806 in this example is an OW space, associated with an OW operation, with dimensions [e0, e1, e2]. The second local space 1810 in this example is an IR space, associated with an IR operation, with dimensions [d0, d1, d2]. The OW operation obtains output data from a first subgraph, e.g. the producer subgraph 1002 of FIG. 10, and the IR operation obtains the output data from the OW operation and provides it to a second subgraph, e.g. the consumer subgraph 1004 of FIG. 10.

In FIG. 18, the first and second transforms 1804, 1808 are both permutative affine transforms. An affine transform can be represented as a matrix of elements, comprising at least one row and at least one column, with values of respective elements defining the nature of the transform. A permutative affine transform for example fulfils the following criteria:
1. The transform has only 1 element which is affine;
2. All elements of the matrix representing the transform are either 0 or 1;
3. Every column of the matrix representing the transform has at most one non-zero element; and
4. Every row of the matrix representing the transform has exactly one non-zero element.

In this case, as both the first and second transforms 1804, 1808 from the chain space 1802 to the first and second local spaces 1806, 1810 are permutative affine, this means that the dimensions in the first and second local spaces 1806, 1810 are direct identity projections of dimensions in the chain space 1802. In other words, the first transform 1804 is a first affine transform to perform a first identity projection of a first set of dimensions of the chain space 1802 (in this case, dimensions e0, e1, e2) to the first local space 1806, and the second transform 1808 is a second affine transform to perform a second identity projection of a second set of dimensions of the chain space 1802 (in this case, dimensions do, d1, d2) to the second local space 1810. A direct identity projection for example involves projecting dimensions from one space (e.g. the chain space 1802) to another space (e.g. the first or second local spaces 1806, 1810) without otherwise modifying the dimensions, e.g. without scaling, clipping, adding or otherwise changing the dimensions.

In this case, to determine the equivalence between at least one first local space dimension of the first local space 1806 and a corresponding at least one second local space dimension of the second local space 1810, a mapping between at least one dimension of the first set of dimensions and a corresponding at least one dimension of the second set of dimensions is identified. In this case, the first and second local spaces 1806, 1810 are equivalent to each other, enabling a mapping between each of the dimensions of the first and second local spaces 1806, 1810 to be determined. FIG. 18 shows a simple example in which each dimension of the first local space 1806 is equivalent to a different respective dimension of the second local space 1810, each of which maps to a different respective dimension of the chain space 1802 (as the chain space 1802 corresponds to a superset of the first and second local spaces 1806, 1810 prior to determining the equivalence therebetween). This allows the equivalence between these dimensions to be identified straightforwardly.

The map of dimensions that are equivalent at an interface 1812 between the first and second local spaces 1806, 1812 can be used to merge these dimensions in the chain space 1802. The interface 1812 shown in FIG. 18 indicates the equivalence between the dimensions of the first local space 1806 and the second local space 1810. Specifically, the interface 1812 shows equivalent dimensions: d0→e0, d1→e1, and d2→e2. This equivalence indicates that these dimensions in the respective local spaces correspond to each other at the interface 1812.

Based on this equivalence between dimensions, a condensed chain space 1814 is generated, which in FIG. 18 is indicated as “New Op Space” with dimensions [d0, d1, d2, d3, e3]. In the condensed chain space 1814, redundant dimensions e0, e1, and e2 have been removed relative to the chain space 1802 since these dimensions are equivalent to do, d1, and d2 respectively. Lines between the condensed chain space 1814 and the original chain space 1802 illustrate how the dimensions are mapped between these spaces. The dimensions d3, e3 in the chain space 1802 are not projected to the first and second local spaces 1806, 1810 so remain unmodified in the condensed chain space 1814.

After determining the equivalence between dimensions in the first local space 1806 and the second local space 1810, the chain of subgraphs can be updated to replace the combination of the output operation and the input operation (in this case, the OW and IR operations) with a connection corresponding to a logical pipe. This logical pipe directly connects the first subgraph to the second subgraph, eliminating the need for intermediate memory operations.

The first and second transforms 1804 and 1808 may be different from each other, as indicated in the Figure. These transforms define how the dimensions in the chain space 1802 are mapped to the first and second local spaces 1806, 1810. By determining the equivalence between respective dimensions of the first and second local spaces 1806, 1810, a logical pipe connecting the first and second subgraphs can be established.

Through this transformation process, an updated chain of subgraphs associated with the condensed chain space 1814 can be generated. The condensed chain space 1814 can be transformed to the first local space 1806 by a first condensed transform, which corresponds to a combination, e.g. a matrix multiplication, of a chain space transform 1816 to transform the condensed chain space 1814 to the chain space 1802 with the first transform 1804 from the chain space 1802 to the first local space 1806. In examples in which the chain space transform 1816 is represented as a matrix C and the first transform 1804 is represented as a matrix T₁, a first condensed transform represented as D₁ corresponds to a matrix multiplication of these matrices, i.e. D₁=T₁C. For example, if the chain space 1802 is represented as a matrix S₁ and the condensed chain space 1814 is represented as a matrix S₂, the condensed chain space 1814 can be transformed to the chain space 1802 via the expression S₁=CS₂. Then, representing the first local space as a matrix L₁, the expression L₁=T₁S₁, can be manipulated to L₁=T₁CS₂, which can be further manipulated to L₁=D₁S₂, which can be used to transform the condensed chain space 1814 to the first local space 1806 via the first condensed transform represented as D₁. Similarly, the condensed chain space 1814 can be transformed to the second local space 1810 by a second condensed transform, which corresponds to a combination, e.g. a matrix multiplication, of the chain space transform 1816 with the second transform 1808 from the chain space 1802 to the second local space 1810. In examples in which the chain space transform 1816 is represented as a matrix C and the second transform 1808 is represented as a matrix T₂, a second condensed transform represented as D₂ corresponds to a matrix multiplication of these matrices, i.e. D₂=T₂C. As for the first local space, the second local space represented as a matrix L₂, can be expressed as L₂=D₂S₂, which can be used to transform the condensed chain space 1814 to the second local space 1810 via the second condensed transform represented as D₂.

Transforms between the condensed chain space 1814 of the updated chain of subgraphs and respective local spaces associated with respective subgraphs and/or operations of the updated chain of subgraphs may be updated similarly. For example, if the chain of subgraphs comprises a third subgraph associated with a third local space and the chain space 1802 is associated with a third transform to the third local space, a third condensed transform from the condensed chain space 1814 to the third local space may be determined for the updated chain of subgraphs, e.g. by performing a matrix multiplication of the chain space transform 1816 with the third transform. In the context of FIG. 2, if the directed graph 202 is taken as the chain of subgraphs to be updated, each of the first to fourth operations 204 to 210 is taken as a respective subgraph, and each of the first to fourth connections 212 to 218 is taken as a respective logical pipe, a respective condensed transform from the condensed chain space 1814 to a respective local space (e.g. section space) associated with each operation 204 to 210 (via the original chain space 1802) may thus be determined for each operation 204 to 210.

In the updated chain of subgraphs, the input and output operations are replaced with a direct connection (corresponding to the logical pipe), improving efficiency by eliminating unnecessary memory operations while preserving the functional relationships between operations in the directed graph. By supporting different transformation matrices between the chain space 1802 and each local space, equivalences between dimensions that would otherwise appear unrelated under a uniform transformation approach can be identified, which enables logical pipes to be created in computational scenarios with complex dimensional relationships, further reducing memory operations.

Supporting different transforms between spaces allows the processor to maintain dimensional coherence across heterogeneous processing elements. Each processing element (e.g. associated with a given operation to be executed) may naturally operate in its own dimensional space, and the ability to apply custom transforms between a (global) chain space and respective local spaces associated with operations to be performed can allow different dimensional representations to be used for different operations. The processor can therefore preserve the natural computational characteristics for each operation while still enabling direct connections between them.

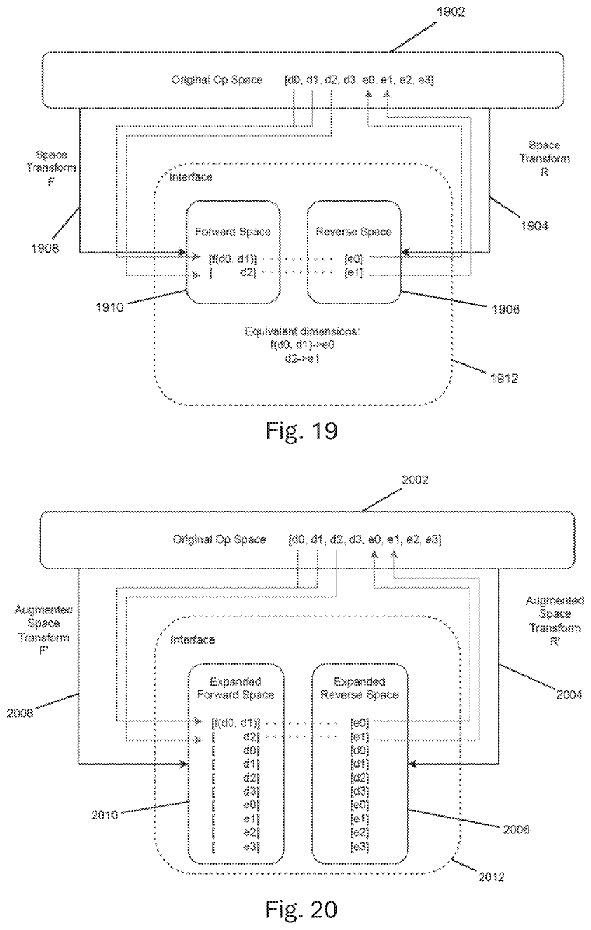

FIG. 19 schematically illustrates various spaces associated with a chain of subgraphs, to illustrate equivalence between dimensions in more complex cases than that of FIG. 18. FIG. 19 shows a chain space 1902, denoted “Original Op Space”, containing multiple dimensions [d0, d1, d2, d3, e0, e1, e2, e3]. The chain space 1902 represents a unified space associated with a chain of subgraphs comprising a first and second subgraph of a directed graph of operations.

A first transform 1904, labelled as “Space Transform R”, transforms dimensions from the chain space 1902 to a first local space 1906, labelled as “Reverse Space”. The first local space 1906 contains dimensions [e0, e1] that are derived from dimensions in the chain space 1902. Similarly, a second transform 1908, labelled as “Space Transform F”, transforms dimensions from the chain space 1902 to a second local space 1910, labelled as “Forward Space”. The second local space 1910 contains dimensions [f(d0, d1), d2] that are derived from dimensions in the chain space 1902. The arrows connecting the chain space 1902 to the local spaces illustrate the transformation of dimensions, with arrows showing the transformation of dimensions do, d1, and d2 from the chain space 1902 to the second local space 1910 and further arrows showing the transformation of dimensions e0 and e1 from the chain space 1902 to the first local space 1906. The first local space 1906 in this example is an OW space, associated with an OW operation and the second local space 1910 in this example is an IR space, associated with an IR operation. The OW operation obtains output data from a first subgraph, e.g. the producer subgraph 1002 of FIG. 10, and the IR operation obtains the output data from the OW operation and provides it to a second subgraph, e.g. the consumer subgraph 1004 of FIG. 10.

An interface 1912 is shown connecting the first local space 1906 and the second local space 1910. The interface 1912 represents the logical connection between the first subgraph and the second subgraph. Within the interface 1912, equivalent dimensions are identified, specifically “f(d0, d1)→e0” and “d2→e1”. These equivalences indicate that dimension e0 in the first local space 1906 can be derived from a function of dimensions d0 and d1 in the chain space 1902, and dimension e1 in the first local space 1906 can be derived from dimension d2 in the chain space 1902.

If a transform from a source space (e.g. the chain space 1902) to a destination space (e.g. the first or second local spaces 1906, 1910) is a surjective transform (which may be referred to as a forward “onto” transform), then all vectors in the destination space have at least one corresponding vector in the source space. For example, an identity transform is surjective while a transform involving a clip is not, because vectors in the destination space outside the clip limit do not have a corresponding vector in the source space. Non-affine transform elements are not surjective, for example. An affine transform matrix A with m rows and n columns is surjective if, for example, m≤n and rank(A)==m (where the rank here refers to the rank in linear algebra terms, and can be computed using Gaussian Elimination). Each transform of a transform stack (e.g. each transform of a plurality of transforms to transform from the source space to the destination space) must be surjective for the whole transform stack to be surjective.

For cases, such as that of FIG. 19, where one of the first or second transforms 1904, 1908 is not permutative affine, then the merging of dimensions is less straightforward. In examples, at least one of the first and second transforms is a surjective transform. In these examples, if both the first and second transforms are not surjective, the merging is aborted. In such cases, the one of the first and second transforms that is surjective can be selected as the reverse transform R, and the other one of the first and second transforms can be selected as the forward transform F. If both the first and second transforms are surjective, then the second transform (in this case, the IR transform) may be selected as the forward transform F. In FIG. 19, the first transform 1904 is surjective, and is selected as the reverse transform R, and the second transform 1908 is non-affine, and is selected as the forward transform F.

To obtain a projection from source dimensions in the chain space 1902 of the forward transform F (in this case, the second transform 1908) back to the source dimensions in the chain space 1902 of the reverse transform R (in this case, the first transform 1904), the forward transform F can be concatenated with the inverse of the reverse transform R. However, the inverse of R is typically not able to recover dimensions in the chain space 1902 not projected in the reverse space (the first local space 1906 in FIG. 19).

To resolve this issue, the transforms F and R are augmented to obtain augmented transforms denoted F′ and R′, such that all the original chain space 1902 dimensions are preserved and recoverable on the reverse of R. This expands the forward and reverse spaces (in this case, the second and first spaces 1910, 1906) to include a copy of the entire original chain space 1902. This way, dimensional information is preserved and recoverable on the inverse of R′ (an inverse of the augmented first transform). Concatenating F′ (the augmented second transform) with the inverse of R′ allows a condensed chain space and a transform from the condensed chain space to the chain space 1902 to be obtained. An example of this is shown in FIG. 20, which will now be discussed.

FIG. 20 illustrates a chain space 2002, labelled as an “Original Op Space”, containing multiple dimensions, shown as [d0, d1, d2, d3, e0, e1, e2, e3]. The chain space 2002 is associated with a chain of subgraphs comprising a first and second subgraph of a directed graph of operations.

The chain space 2002 is transformable to an augmented first local space 2006 and an augmented second local space 2010 by augmented first and second transforms 2004, 2008, labelled as “Augmented Space Transform R′” and “Augmented Space Transform F′” respectively. The augmented first local space 2006 in this example is an OW space, associated with an OW operation and the augmented second local space 2010 in this example is an IR space, associated with an IR operation. The OW operation obtains output data from a first subgraph, e.g. the producer subgraph 1002 of FIG. 10, and the IR operation obtains the output data from the OW operation and provides it to a second subgraph, e.g. the consumer subgraph 1004 of FIG. 10.

In FIG. 20, the augmented first transform 2004 is obtained by augmenting the first transform 1904 of FIG. 19 by appending the chain space 2002 to the first transform 1904 and the augmented second transform 2008 is obtained by augmenting the second transform 1908 of FIG. 19 by appending the chain space 2002 to the second transform 1908. The augmented first transform 2004 transforms the chain space 2002 to the augmented first local space 2006, which comprises the first local space 1906 of FIG. 19 and the chain space 2002, and the augmented second transform 2008 transforms the chain space 2002 to the augmented second local space 2010, which comprises the second local space 1910 of FIG. 19 and the chain space 2002. The augmented first local space 2006 contains dimensions [e0, e1, do, d1, d2, d3, e0, e1, e2, e3], while the augmented second local space 2010 contains dimensions [f(d0, d1), d2, do, d1, d2, d3, e0, e1, e2, e3]. These augmented local spaces preserve the dimensions from the original chain space 2002 while adding transformed dimensions obtained by the respective transforms from the chain space 2002.

As shown in FIG. 20, there is equivalence between dimensions in the augmented first local space 2006 and the augmented second local space 2010 at an interface 2012 between these dimensions. In this case, the dimension f(d0, d1) in the augmented second local space 2010 corresponds to the dimension e0 in the augmented first local space 2006, and the dimension d2 in the augmented second local space 2010 corresponds to the dimension e1 in the augmented first local space 2006.

By including the augmented first and second transforms 2004, 2008, a copy of the source space (in this case, the chain space 2002) can be preserved in the destination space (in this case, the augmented first and second spaces 2006, 2010), allowing dimensions from the chain space 2002 to be recovered when applying the transforms.

With this approach, the chain space 2002 is transformable back to itself, via the first and second augmented local spaces 2006, 2010, using one of the augmented first transform and the augmented second transform 2004, 2008, and an inverse of the other one of the augmented first transform and the augmented second transform 2004, 2008, provided at least the other one of the augmented first transform and the augmented second transform 2004, 2008 is surjective (so that this transform can be inverted without losing information). This is indicated in FIG. 20 by the arrows from respective dimensions in the chain space 2002 down to the augmented second local space 2010, via equivalence between respective dimensions in the augmented first and second local spaces 2006, 2010 at the interface 2012, and the further arrows from these dimensions in the augmented first local space 2006 back to further dimensions in the chain space 2002.

In FIG. 20, the augmented second transform 2008 is non-affine, and is taken as an augmented forward transform F′ and the augmented first transform 2004 is surjective, and is taken as an augmented reverse transform R′. In other examples, though, the augmented second transform 2008 may be surjective and the augmented first transform 2004 may be non-affine, if the augmented first and second transforms 2004, 2008 are designated the reverse and forward transforms, respectively. In still further examples, both the augmented first and second transforms 2004, 2008 may be surjective.

By establishing an equivalence between dimensions in the augmented first local space 2006 and the augmented second local space 2010, the OW and IR operations (associated with the augmented first and second local spaces 2006, 2010 respectively) can be replaced by a logical pipe and the chain of subgraphs can be updated accordingly.

The augmentation of transforms allows the system to handle cases where transforms are not permutative affine, ensuring that space transformations can be applied effectively across a wide range of computational graphs. The augmentation of transforms to create augmented local spaces that include the chain space preserves dimensional information that would otherwise be lost during transformation. When a transform is applied to convert from one space to another, certain dimensions or relationships between dimensions may be altered or eliminated. By augmenting the transforms to retain the original chain space within the resulting local spaces, access to original dimensional data can be maintained throughout the transformation process. This preservation of dimensional information enables more robust space transformations and allows for accurate reconstruction of the original chain space when needed.

As an example, given a simple linear transform y=f(x), the augmented transform can be written as (y,x)=f′(x). For a space transformation comprising a stack of transform elements (e.g. a plurality of transforms, which may include affine and non-affine transforms), each transform element can be handled appropriately as part of the augmentation to enable dimensional information of the chain space 2002 to be retained.

For a forward stack of transform elements (e.g. representing the one of the first and second local transforms selected as the forward transform F, which in this case is the second local transform), a different approach may be taken depending on the nature of the transform element within the stack (e.g. depending on the nature of the transform of the plurality of transforms corresponding to the stack). For a first affine transform to be applied as part of the plurality of transforms, the first affine transform may be modified to retain a copy of the source space (the chain space 2002) in its destination space. This may be represented as modifying an original first affine transform:

$$[ \begin{matrix}A & b \\ 0 & 1\end{matrix} ]$$

to include a suitably-sized identity matrix, I, to obtain an augmented first affine transform:

$$[ \begin{matrix}A & b \\ I & 0 \\ 0 & 1\end{matrix} ]$$

For subsequent affine transforms, applied after the first affine transform, these may also be modified to maintain the copy of the source space, from original subsequent affine transforms of the form:

$$[ \begin{matrix}A & b \\ 0 & 1\end{matrix} ]$$

to augmented subsequent affine transforms of the form:

$$[ \begin{matrix}A & 0 & b \\ 0 & I & 0 \\ 0 & 0 & 1\end{matrix} ]$$

Non-affine transforms may not be otherwise modified if the copy of the source space is retained after applying the non-affine transform. For example, for a clip operation, the copy of the source space may be appended behind the original destination space, for example leading to no modification on a clip axis. For an integer division operation, the dividing vector may be expanded with additional elements with values set to 1 to account for the extra source space dimensions in the destination space.

A reverse stack of transform elements (e.g. representing the other one of the first and second local transforms, which is selected as the reverse transform R, which in this case is the first local transform) may also be augmented. As for the forward stack, a different approach may be taken depending on the nature of the transform element within the stack (e.g. depending on the nature of the transform of the plurality of transforms corresponding to the stack). For a first affine transform to be applied as part of the plurality of transforms, the first affine transform may be modified to use the copy of the source space to recover dimensions when there is no projection present from the original reverse affine matrix. This can be identified by examining non-zero rows of the reverse affine matrix. This may be represented as modifying an original first affine transform:

$$[ \begin{matrix}rA & b \\ 0 & 1\end{matrix} ]$$

to obtain an augmented first affine transform:

$$m [ \begin{matrix}rA & 0 & b \\ 0 & 0 & 1\end{matrix} ] + ( 1 - m ) [ \begin{matrix}0 & I & 0 \\ 0 & 0 & 1\end{matrix} ]$$

where

$$m = [ \begin{matrix}{m}_{0} \\ {m}_{1} \\ … \\ 0\end{matrix} ]$$

and mᵢ=1 if the full unaugmented inverse transform is projected to dimension i of the source space, and 0 otherwise.
For subsequent affine transforms, applied after the first affine transform, these may also be modified to maintain the copy of the source space, from original subsequent affine transforms of the form:

$$[ \begin{matrix}rA & b \\ 0 & 1\end{matrix} ]$$

to augmented subsequent affine transforms of the form:

$$[ \begin{matrix}rA & 0 & b \\ 0 & I & 0 \\ 0 & 0 & 1\end{matrix} ]$$

Similar to the handling of non-affine transforms for the forward stack, non-affine transforms for the reverse stack may not be otherwise modified if the copy of the source space is retained after applying the non-affine transform. For example, for a clip operation, the copy of the source space may be appended behind the original destination space, for example leading to no modification on a clip axis. For an integer division operation, the dividing vector may be expanded with additional elements with values set to 1 to account for the extra source space dimensions in the destination space.

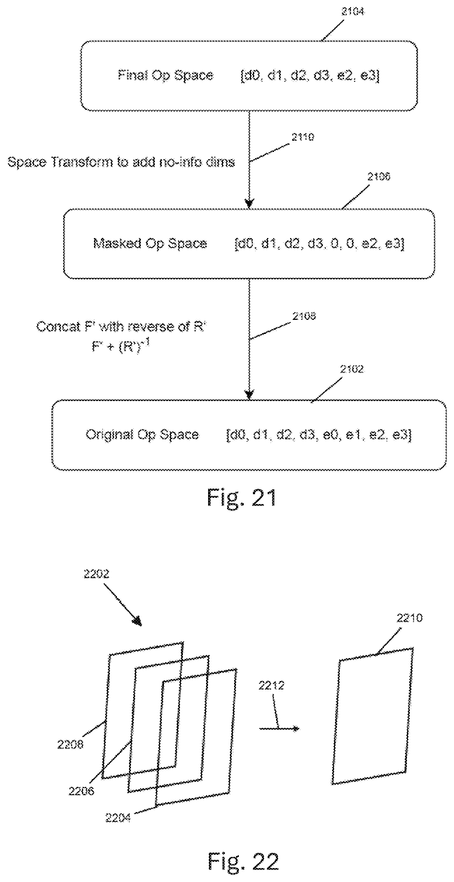

When equivalences are determined between dimensions in different local spaces, such as between dimensions associated with output operations and input operations, the chain space dimensionality can be reduced. This is shown in FIG. 21, which shows a transformation between a chain space 2102 (which is the same as the chain space 2002 of FIG. 20) and the condensed chain space 2104 (shown in FIG. 21 as a “Final Op Space”), via an intermediate chain space 2106 (shown in FIG. 21 as a “Masked Op Space”). The chain space 2102 is shown at the bottom of FIG. 21 and contains dimensions [d0, d1, d2, d3, e0, e1, e2, e3]. The original chain space 2102 represents the full dimensionality of the chain space associated with the chain of subgraphs discussed with reference to FIGS. 19 and 20. In the context of processing chains of subgraphs, this original chain space 2102 may include dimensions that can be reduced based on equivalences identified between local space dimensions. For example, a chain space dimensionality of the chain space 2102 can be reduced, based on the equivalence, to obtain the condensed chain space 2104 with a condensed chain space dimensionality which is less than the chain space dimensionality. In FIG. 21, the condensed chain space 2104 contains dimensions [d0, d1, d2, d3, e2, e3], which, as can be seen in FIG. 20, correspond to unique dimensions of the chain space 2002, with dimensions of the chain space 2002 that can be derived from other dimensions (in this case, dimensions e0, e1) omitted from the condensed chain space 2104. The condensed chain space 2104 represents the reduced dimensionality space after equivalences have been applied. The updated chain of subgraphs may be associated with the condensed chain space 2104 rather than the chain space 2002, to make the updated chain of subgraphs more computationally efficient to store and process.

The condensed chain space 2104 is transformable to the chain space 2102 using a chain space transform. In the example of FIG. 21, this transformation comprises increasing 2110 the condensed chain space dimensionality to the chain space dimensionality to generate the intermediate chain space 2106. This is indicated in FIG. 21 as a space transform to add no-information (no-info) dimensions, which are not present in the condensed chain space 2104. The intermediate chain space 2106 comprises each dimension of the condensed chain space 2104 and respective predetermined values for each dimension of the chain space 2102 that is absent from the condensed chain space 2104. The intermediate chain space 2106 can be considered a masked operation space, where certain dimensions are masked with placeholder, e.g. predetermined, values. As shown in the Figure, the intermediate chain space 2106 contains dimensions [d0, d1, d2, d3, 0, 0, e2, e3], where the dimensions e0 and e1 (which are absent from the condensed chain space 2104 but present in the chain space 2102) have been replaced with predetermined values of zero to indicate that they contain no information and will be derived from other dimensions.

A chain space transform 2108 is applied to transform the intermediate chain space 2106 to the chain space 2102. This transform is represented in FIG. 21 as a concatenation of a forward transform F′ with the inverse of a reverse transform R′ (where F′ and R′ are as described with reference to FIG. 20). This transformation enables the dimensionality of the original chain space 2102 to be recovered from the intermediate chain space 2106, while maintaining the relationships between respective dimensions. The transformation from the condensed chain space 2104 back to the chain space 2102 through the intermediate chain space 2106 generation provides a simple mechanism for reducing the dimensionality of the chain space 2102, while retaining sufficient information to enable the original chain space 2102 to be recovered.

The condensed chain space 2104 provides computational efficiency by eliminating redundant dimensions identified through equivalence relationships. When the chain of subgraphs is updated based on equivalence, dimensions that contain duplicate or derivable information can be removed, allowing operations to be performed in a more compact representation. The transformability between the condensed chain space 2104 and the original chain space 2102 ensures that other operations in the chain can be appropriately updated to work with the reduced dimensionality while maintaining correct results.

The approach to chain space dimensionality reduction offers flexibility in handling various types of transformations between operation spaces. The processor can accommodate complex transforms to local spaces, including non-affine transforms that involve non-linear relationships between dimensions. This capability extends the range of operation chains that can be successfully resolved into logical pipes, enabling optimization of more sophisticated computational graphs with diverse dimensional structures.

### Transform Combination Approaches

FIG. 22 shows a schematic illustration of a plurality of transforms 2202 that can be combined to form a combined affine transform 2210. The plurality of transforms 2202 includes a first affine transform 2204, a second affine transform 2206, and a third affine transform 2208. As each of these transforms is affine, they can be combined through a combine operation 2212 to produce the combined affine transform 2210. The combine operation 2212 represents a matrix multiplication of the respective transform matrices, resulting in a single transform matrix that represents the combined affine transform 2210. Augmentation of transforms as described with reference to FIGS. 19 to 21 can enable dimensions of a chain space to be fully recoverable. However, augmentation in this manner can cause matrices (e.g. affine matrices) representing at least one of the transforms to become very large. There may be a constraint on the maximum size of the task data generated using the methods herein, which restricts the size of each affine matrix to a particular size, e.g. as defined in accordance with an architecture of a processor to execute the task. For affine matrices, such as the plurality of transforms 2202 of FIG. 22, the overall size can be reduced by performing a matrix multiplication of consecutive affine transforms, to collapse the consecutive affine transforms into the combined affine transform 2210. However, the presence of non-affine transforms between affine transforms prevents the direct merging of the affine transforms through simple matrix multiplication.

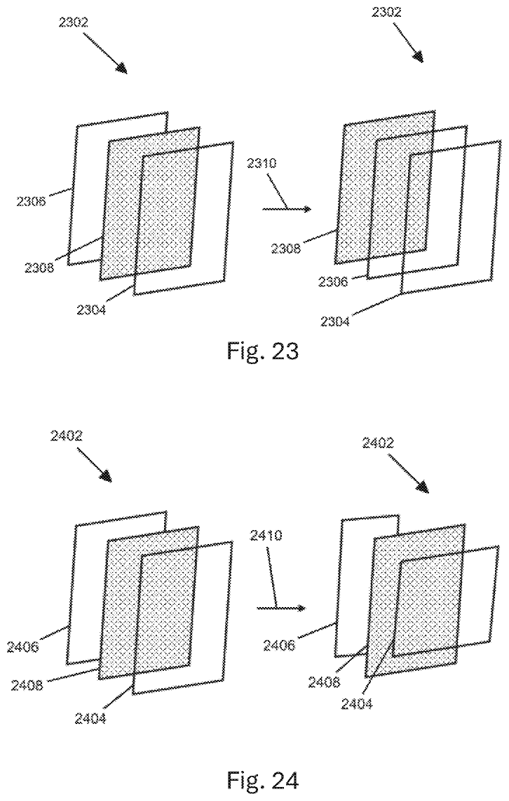

When a non-affine transform such as a clip operation is present between affine transforms in a plurality of transforms 2202, special handling may be required before the combine operation 2212 can be performed. For example, the plurality of transforms 2202 may be rewritten to reduce a size of the affine matrices, as shown in FIGS. 23 and 24. FIG. 23 illustrates a plurality of transforms 2302 and a reordering operation 2310. The plurality of transforms 2302 includes a first affine transform 2304 (which may be referred to as an affine transform), a second affine transform 2306 (which may be referred to as a further affine transform) and a non-affine transform 2308. The non-affine transform 2308 is initially located between the first and second affine transforms 2304, 2306 within the plurality of transforms 2302 (which is an example of a transform stack).

In FIG. 23, the plurality of transforms 2302 is then ordered 2310 such that the non-affine transform 2308 is after the first and second affine transforms 2304, 2306, allowing the first and second affine transforms 2304, 2306 to be combined, e.g. by matrix multiplication, for example using the combine operation 2212 of FIG. 22. The reordering of FIG. 23 can be performed under certain conditions. For instance, a clip operation (which is an example of a non-affine transform) can be reordered to come after a combined affine matrix generated by combining the first and second affine transforms 2304, 2306 if, for example, for every non-zero element in the column of the combined affine matrix corresponding to the clipped dimension, the row of that element only has zero entries in all other columns.

FIG. 24 illustrates a further example of rewriting a plurality of transforms 2402 including a first affine transform 2404, a second affine transform 2406, and a non-affine transform 2408. The non-affine transform 2408 is positioned between the first affine transform 2404 and the second affine transform 2406, which prevents direct merging of the two affine transforms. The non-affine transform 2408 may comprise various non-linear operations such as a clip operation, integer division, negation, remainder, or split dimension operations.

When a non-affine transform such as the non-affine transform 2408 is positioned between affine transforms, it can prevent the affine transforms from being collapsed or merged together through matrix multiplication. This can result in larger matrices that may be computationally expensive to process. To address this issue, FIG. 24 illustrates an affine portion removal 2410 process that may be performed. The affine portion removal 2410 identifies and removes a portion (e.g. column(s) and/or row(s) of at least one affine matrix) of an affine transform (e.g. the first and/or second affine transforms 2404, 2406) that would be unprojected by a further affine transform, e.g. performed subsequently.

This can significantly reduce the size of the matrices while preserving the essential transformational properties. In other words, unprojected dimensions of the first and/or second affine transforms 2404, 2406 can be removed. For example, if the non-affine transform 2408 is a clip operation and if a column in the second affine transform 2406 matrix is beyond a clipped axis and that column contains all zero entries, indicating that a particular dimension is not projected to the output space, that column and the corresponding row in the first affine transform 2404 matrix (performed prior to the second affine transform 2406) can be removed. This optimization reduces the size of the matrices involved in the transformation, making the computation more efficient.

The right side of FIG. 24 shows the result after the affine portion removal 2410 has been applied to the plurality of transforms 2402 shown on the left side. The matrices representing the first affine transform 2404 and the second affine transform 2406 have been reduced in size while maintaining their functional properties. This optimization helps to ensure that the transforms can be efficiently processed by the hardware, particularly when there are constraints on the maximum dimensions that can be handled by the processor architecture. This optimization may also reduce a memory footprint of the processor, such as a graph compiler and simplify debugging of the space transform stack.

Before the affine portion removal 2410, elements of at least one of the first and second affine transforms 2404, 2406 may be permuted to increase a size of the portion of the at least one of these transforms 2404, 2406 that is removed by the affine portion removal 2410. For example, the rows of the first affine transform 2404 and the columns of the second affine transform 2406 may be permuted to decrease the size of the clipped axes and increase the size of the portion removed by the affine portion removal 2410. This may further reduce the size of the plurality of transforms 2402, further improving processing efficiency in performing the transforms 2402. For example, the permutation operation can reorganize the matrix structure of the transforms 2402 to maximize the number of elements that can be safely removed without affecting the transformation result. By increasing the size of the removable portion, the system achieves more aggressive matrix size reduction and improves the computational efficiency of the transformation process.

### Hardware Implementation

A data structure in the form of a directed graph may comprise plural sequenced operations that are connected to one another for execution in a chain. Described below is an example hardware arrangement for executing chained operations for at least a portion of a directed graph.

FIG. 25 shows schematically an example of a data processing system 2500 including offload processor 2530 which may act as a co-processor or hardware accelerator unit for a host processing unit 2510. The host processing unit 2510 is an example of a processor configured to perform the methods herein to generate task data, such as the methods described with reference to FIGS. 1 to 15 and/or with reference to FIGS. 16 to 24. The host processing unit 2510 may be or comprise a graph compiler. For example, the host processing unit 2510 may generate the task data then compile the task data into machine instructions for sending to the processor 2530 to instruct the processor 2530 to execute the task.

The processor 2530 is configured to operate on tasks represented in the form of graphs of operations (such as the further directed graph of operations described herein), and may be referred to as a graph processor. The processor 2530, e.g. a graph processor, may be or comprise a neural engine and/or a neural processing unit (NPU), for example as described further below. It will be appreciated that the types of hardware accelerator which the processor 2530 may provide dedicated circuitry for is not limited to that of Neural Processing Units (NPUs) or Graphics Processing units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g., supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable, to utilize some of the GPU's existing resources (e.g., such that at least some functional units and resource of the GPU can effectively be shared between the different hardware accelerator circuitry, for instance), whilst still allowing an improved (more optimized) performance compared to performing all the processing with general purpose execution.

As such, the processor 2530 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g., an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor, this means that the machine learning processing circuit is preferably then operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 25, the processor 2530 is arranged to receive a command stream 2520 from a host processor 2510, such as a central processing unit (CPU). The command stream comprises at least one command in a given sequence, each command to be executed, and each command may be decomposed into a number of tasks, such as tasks discussed in this document. As such, the command stream may comprise task data generated according to the methods herein, which may be decomposed into at least one task. These tasks may be self-contained operations, such as a given machine learning operation or a graphics processing operation. It will be appreciated that there may be other types of tasks depending on the command.

The command stream 2520 is sent by the host processor 2510 and is received by a command processing unit 2540 which is arranged to schedule the commands within the command stream 2520 in accordance with their sequence. The command processing unit 2540 is arranged to schedule the commands and decompose each command in the command stream 2520 into at least one task. Once the command processing unit 2540 has scheduled the commands in the command stream 2520, and generated a plurality of tasks for the commands, the command processing unit issues each of the plurality of tasks to at least one compute unit 2550a, 2550b each of which are configured to process at least one of the plurality of tasks. The compute units 2550a, 2550b are examples of respective processing modules, such as graph processing modules, for executing graphs represented by task data generated according to the methods described herein.

The processor 2530 comprises a plurality of compute units 2550a, 2550b. Each compute unit 2550a, 2550b, may be a shader core of a GPU specifically configured to undertake a number of different types of operations, however it will be appreciated that other types of specifically configured processor may be used, such as a general-purpose processor configured with individual compute units, such as compute units 2550a, 2550b. Each compute unit 2550a, 2550b comprises a number of components, and at least a first processing module 2552a, 2552b for executing tasks of a first task type, and a second processing module 2554a, 2554b for executing tasks of a second task type, different from the first task type. In some examples, the first processing module 2552a, 2552b may be a processing module for processing neural processing operations, such as those which would normally be undertaken by a separate NPU. In these cases, the first processing module 2552a, 2552b is for example a neural engine. Similarly, the second processing module 2554a, 2554b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader takes, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 2540 issues tasks of a first task type to the first processing module 2552a, 2552b of a given compute unit 2550a, 2550b, and tasks of a second task type to the second processing module 2554a, 2554b of a given compute unit 2550a, 2550b. The command processing unit 2540 would issue machine learning/neural processing tasks to the first processing module 2552a, 2552b of a given compute unit 2550a, 2550b where the first processing module 2552a, 2552b is optimized to process neural network processing tasks, for example by comprising an efficient means of handling a large number of multiply-accumulate operations. Similarly, the command processing unit 2540 would issue graphics processing tasks to the second processing module 2554a, 2554b of a given compute unit 2550a, 2550b where the second processing module 2552a, 2554a is optimized to process such graphics processing tasks. In some examples, the first and second may both be neural processing tasks issued to a first processing module 2552a, 2552b, which is a neural engine. Such a neural processing task may involve the processing of a tensor, e.g., representing a feature map, with weights associated with a layer of a neural network.

In addition to comprising a first processing module 2552a, 2552b and a second processing module 2554a, 2554b, each compute unit 2550a, 2550b also comprises a memory in the form of a local cache 2556a, 2556b for use by the respective processing module 2552a, 2552b, 2554a, 2554b during the processing of tasks. Examples of such a local cache 2556a, 2556b is a L1 cache. The local cache 2556a, 2556b may, for example, a synchronous dynamic random-access memory (SDRAM). For example, the local cache 2556a, 2556b may comprise a double data rate synchronous dynamic random-access memory (DDR-SDRAM). It will be appreciated that the local cache 2556a, 2556b may comprise other types of memory.

The local cache 2556a, 2556b is used for storing data relating to the tasks which are being processed on a given compute unit 2550a, 2550b by the first processing module 2552a, 2552b and second processing module 2554a, 2554b. It may also be accessed by other processing modules (not shown) forming part of the compute unit 2550a, 2550b the local cache 2556a, 2556b is associated with. However, in some examples, it may be necessary to provide access data associated with a given task executing on a processing module of a given compute unit 2550a, 2550b to a task being executed on a processing module of another compute unit (not shown) of the processor 2530. In such examples, the processor 2530 may also comprise storage 2560, for example a cache, such as an L₂ cache, for providing access to data use for the processing of tasks being executed on different compute units 2550a, 2550b.

By providing a local cache 2556a, 2556b tasks which have been issued to the same compute unit 2550a, 2550b may access data stored in the local cache 2556a, 2556b, regardless of whether they form part of the same command in the command stream 2520. The command processing unit 2540 is responsible for allocating tasks of commands to given compute units 2550a, 2550b such that they can most efficiently use the available resources, such as the local cache 2556a, 2556b, thus reducing the number of read/write transactions required to memory external to the compute units 2550a, 2550b, such as the storage 2560 (L2 cache) or higher level memories. One such example, is that a task of one command issued to a first processing module 2552a of a given compute unit 2550a, may store its output in the local cache 2556a such that it is accessible by a second task of a different (or the same) command issued to a given processing module 2552a, 2554a of the same compute unit 2550a.

One or more of the command processing unit 2540, the compute units 2550a, 2550b, and the storage 2560 may be interconnected using a bus. This allows data to be transferred between the various components. The bus may be or include any suitable interface or bus. For example, an ARM® Advanced Microcontroller Bus Architecture (AMBA®) interface, such as the Advanced extensible Interface (AXI), may be used.

FIG. 26 is a schematic diagram of a neural engine 2600, which in this example is used as a first processing module 2552a, 2552b in a data processing system 2500 in accordance with FIG. 25. The neural engine 2600 includes a command and control module 2610. The command and control module 2610 receives tasks from the command processing unit 2540 (shown in FIG. 25), and also acts as an interface to storage external to the neural engine 2600 (such as a local cache 2556a, 2556b and/or a L2 cache 2560) which is arranged to store data to be processed by the neural engine 2600 such as data representing a tensor, or data representing a stripe of a tensor. The external storage may additionally store other data to configure the neural engine 2600 to perform particular processing and/or data to be used by the neural engine 2600 to implement the processing such as neural network weights.

The command and control module 2610 interfaces to a handling unit 2620, which is for example a traversal synchronization unit (TSU). In this example, each task corresponds to a stripe of a tensor which is to be operated upon in accordance with a sequence of operations according to at least a portion (e.g. a sub-graph) of the graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 2620 splits data representing a stripe of a feature map into a plurality of blocks of data, each of which represents a respective part of the feature map. The handling unit 2620 also obtains, from storage external to the neural engine 2600 such as the L2 cache 2560, task data defining operations selected from an operation set comprising a plurality of operations. In this example, the operations are structured as a chain of operations representing a sequence of layers of the neural network. A block of data is allocated as an input to one of the operations by the handling unit 2620.

The handling unit 2620 coordinates the interaction of internal components (also referred to as execution units herein) of the neural engine 2600, which include a weight fetch unit 2622, an input reader 2624, an output writer 2626, a direct memory access (DMA) unit 2628, a dot product unit (DPU) array 2630, a vector engine 2632, a transform unit 2634, an accumulator buffer 2636, and a storage 2638, for processing of blocks of data. The data dependencies across the functional units are tracked by the handling unit 2620. Processing is initiated by the handling unit 2620 in a functional unit if all input blocks are available and space is available in the storage 2638 of the neural engine 2600. The storage 2638 may be considered to be a shared buffer, in that various functional units of the neural engine 2600 share access to the storage 2638.

In the context of a directed graph representing the operations to be performed, each of the internal components that operates upon data can be considered to be one of two types of component. The first type of component is an execution unit (and is identified within the neural engine 2600 as such) that maps to a section that performs a specific instance of an operation within the graph. For example, the weight fetch unit 2622, input reader 2624, output writer 2626, dot product unit array 2630, vector engine 2632, transform unit 2634 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The connections between sections in the graph representing the neural network are also referred to as pipes (also referred to herein as logical pipes) within the context of the graph. These pipes can also be mapped to the uniquely identified physical storage elements of a storage in the neural engine. For example, the accumulator buffer 2636 and storage 2638 (and portions thereof) can each be regarded as a storage element that can act to store data for a pipe within the graph. The pipes act as connections between the sections (as executed by execution units) to enable a sequence of operations as defined in the graph to be chained together within the neural engine 2600. Put another way, the logical dataflow of the graph can be mapped to the physical arrangement of execution units and storage elements within the neural engine 2600 by the handling unit 2620. Under the control of the handling unit 2620, execution can be scheduled on the execution units and data can be passed between the execution units via the storage elements in accordance with the mapping, such that the chained operations of a graph can be executed without needing to write data memory external to the neural engine 2600 between executions. The handling unit 2620 is configured to control and dispatch work representing performing an operation of the graph on at least a portion of the data provided by a pipe.

The weight fetch unit 2622 fetches weights associated with the neural network from external storage and stores the weights in the storage 2638. The input reader 2624 reads data to be processed by the neural engine 2600 from external storage, such as a block of data representing part of a tensor. The output writer 2626 writes data obtained after processing by the neural engine 2600 to external storage. The weight fetch unit 2622, input reader 2624 and output writer 2626 interface with the external storage (which is for example the local cache 2556a, 2556b, which may be a L₁ cache such as a load/store cache) via the DMA unit 2628.

Data is processed by the DPU array 2630, vector engine 2632 and transform unit 2634 to generate output data corresponding to an operation in the graph. The result of each operation is stored in a specific pipe within the neural engine 2600. The DPU array 2630 is arranged to perform one or more operations associated with a dot product operation between two operands, such as between an array of weights and a corresponding block of data (e.g., representing part of a tensor). The vector engine 2632 is arranged to perform elementwise operations, for example to apply scale parameters to scale an output of a dot product calculated by the DPU array 2630. Data generated during the course of the processing performed by the DPU array 2630 and the vector engine 2632 may be transmitted for temporary stage in the accumulator buffer 2636 which acts as a pipe between the previous operation and the subsequent operation, from where it may be retrieved by either the DPU array 2630 or the vector engine 2632 (or another different execution unit) for further processing as desired.

The transform unit 2634 is arranged to perform in-block transforms such as dimension broadcasts or axis swaps. The transform unit 2634 obtains data from a pipe, such as storage 2638 (e.g., after processing by the DPU array 2630 and/or vector engine 2632), and writes transformed data back to the storage 2638.

To make efficient use of the storage 2638 available within the neural engine 2600, the handling unit 2620 determines an available portion of the storage 2638, which is available during execution of part of a first task (e.g., during processing of a block of data associated with the first task by the DPU array 2630, vector engine 2632 and/or transform unit 2634). The handling unit 2620 determines a mapping between at least one logical address associated with data generated during execution of a second task (e.g., by processing of a block of data associated with the second task by the DPU array 2630, vector engine 2632 and/or transform unit 2634) and at least one physical address of the storage 2638 corresponding to the available portion. The logical address is for example a global address in a global coordinate system. Hence, by altering the physical address corresponding to a given logical address, the handling unit 2620 can effectively control usage of the storage 2638 without requiring a change in software defining the operation to be performed, as the same logical address can still be used to refer to a given element of the tensor to be processed. The handling unit 2620 identifies the at least one physical address corresponding to the at least one logical address, based on the mapping, so that data associated with the logical address is stored in the available portion. The handling unit 2620 can perform the mapping process according to any of the examples herein.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements. In particular, a single execution unit may be configured at different instances in time to execute different instances of a convolution operation (e.g., first and second sections). Similarly, the input reader may be required to read data as part of different sections in the graph. The same can be said for storage elements and pipes.

All storage in the neural engine 2600 may be mapped to corresponding pipes, including look-up tables, accumulators, etc. Some storage may be relatively fixed purpose, for example, if the hardware were limited to one convolution operation per graph the accumulator buffer might also be limited to being mapped to one pipe, and scale/bias/shift buffer might be limited to being mapped to one pipe; however, both would likely be double buffered. If the neural engine supports 2 look-up tables (LUTs), then a maximum of 2 pipes could be used to target the LUTs to avoid needing to thrash the LUT storage; LUT pipes might then be single buffered. All other pipes could be mapped to a common Shared Buffer (or portions thereof) with fewer restrictions. Width and height of pipe can also be programmable, resulting a highly configurable mapping between pipes and storage elements within the neural engine 2600.

Ordering of execution of the sections is implied by dependencies on inputs. A memory load operation has no data dependencies (unless it is a gather operation), so is implicitly early in the graph. The consumer of the pipe the memory read produces is implicitly after the memory read. A memory store operation is near the end of the graph, as it produces no pipes for other operations to consume. The sequence of execution of a chain of operations is therefore handled by the handling unit 2620 as will be explained in more detail later.

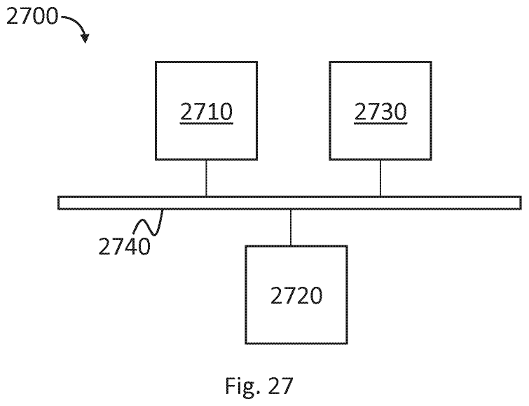

FIG. 27 shows schematically a system 2700 for allocating handling data, and in some examples generating a plurality of blocks of input data for processing.

The system 2700 comprises host processor 2710 such as a central processing unit, or any other type of general processing unit. The host processor 2710 issues a command stream comprising a plurality of commands, each having a plurality of tasks associated therewith.

The system 2700 also comprises an offload processor 2730a, which may be similar to or the same as the processor 2530 of FIG. 25 and may comprise at least some of the components of and/or be configured to perform the methods described above. The processor 2730a comprises at least a plurality of compute units 2550a, 2550b and a command processing unit 2540. Each compute unit may comprise a plurality of processing modules each configured to perform at least one type of operation. The system 2700 may also include at least one further processor 2730b, which may be the same as the processor 2730a. The processor 2730a, and the host processor 2710 may be combined as a System on Chip (SoC) or onto multiple SoCs to form one or more application processors.

The system 2700 also comprises memory 2720 for storing data generated by the tasks externally from the processor 2730, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 2550a, 2550b of a processor 2730 so as to maximize the usage of the local cache 2556a, 2556b.

In some examples, the system 2700 may comprise a memory controller (not shown), which may be a dynamic memory controller (DMC). The memory controller is coupled to the memory 2720. The memory controller is configured to manage the flow of data going to and from the memory. The memory may comprise a main memory, otherwise referred to as a ‘primary memory’. The memory may be an external memory, in that the memory is external to the system 2700. For example, the memory 2720 may comprise ‘off-chip’ memory. The memory may have a greater storage capacity than local caches of the processor 2730 and/or the host processor 2710. In some examples, the memory 2720 is comprised in the system 2700. For example, the memory 2720 may comprise ‘on-chip’ memory. The memory 2720 may, for example, comprise a magnetic or optical disk and disk drive or a solid-state drive (SSD). In some examples, the memory 2720 comprises a synchronous dynamic random-access memory (SDRAM). For example, the memory 2720 may comprise a double data rate synchronous dynamic random-access memory (DDR-SDRAM).

One or more of the host processor 2710, the processor 2730, and the memory 2720 may be interconnected using a system bus 2740. This allows data to be transferred between the various components. The system bus 2740 may be or include any suitable interface or bus. For example, an ARM® Advanced Microcontroller Bus Architecture (AMBAR) interface, such as the Advanced extensible Interface (AXI), may be used.

A system for implementing the methods herein, such as the system 2700, may for example be a system on a chip (SoC). Such a system may comprise a host processor, for example be a central processing unit (CPU). The system may further comprise an offload processor such as a graphics processing unit (GPU), Neural Processing Unit (NPU), an Application-Specific Integrated Circuits (ASIC) or a Field-Programmable Gate Array (FPGA). The offload processor may comprise a command processing unit connected to one or more processing modules. The processing module may for example be a neural engine (NE). The processing module may comprise a storage with a plurality of storage elements, and a plurality of execution units. Such a system may be used to execute operations on input data. The operations may be in the form of a directed graph. The host processor may instruct the processing module to execute the operations. The processing module may have different hardware constraints, such as the number and type of execution units, memory constraints of the storage and storage elements and storage bandwidth of the storage and/or storage elements.

### Additional Variations

The chain space dimensionality described in the preceding sections can be implemented such that it corresponds to a sum of the dimensionality of the consumer subgraph space and the dimensionality of the producer subgraph space. This summation of dimensionalities enables the chain space to handle operation sequences with operation spaces that are more complex than any single section space. By combining the dimensions from both subgraph spaces, the chain space provides a comprehensive framework for executing the combined operations efficiently.

The chain space can be defined by a multi-dimensional nested loop structure comprising multiple dimensions to be iterated over to execute the chain of base subgraphs. This nested loop structure may include at least one inner dimension and at least one outer dimension, outwards of the at least one inner dimension, The at least one inner dimension may define the producer subgraph space and the at least one outer dimension may define the consumer subgraph space. This arrangement ensures proper execution ordering, as the consumer dimensions being positioned as outer dimensions relative to the producer dimensions guarantees that a complete traversal of the producer subgraph space occurs for each block issued in the consumer subgraph space.

The chaining methodology supports merging a chain of base subgraphs with additional base subgraphs or with other chains of base subgraphs. This extensible chain construction capability enables building increasingly complex operation sequences while maintaining dimensional coherence. The ability to merge chains with additional elements provides flexibility in constructing processing pipelines, e.g. for neural network processing, which can adapt to various computational requirements.

A chain may include multiple instances of the same operation or the same base subgraph. This operation reuse efficiency supports more efficient handling of repeated patterns in neural network computations. For example, a chain may comprise multiple convolution operations, enabling more efficient execution of complex architectures by reducing memory traffic between operations and maintaining information across the convolution sequence.

Base subgraphs within a chain may include directed cycles, providing support for recurrent neural network structures and feedback loops that traditional chaining approaches with strict producer-consumer relationships cannot efficiently process. This capability extends the applicability of the chaining methodology to a broader range of neural network architectures.

The plurality of base subgraphs from which chain(s) can be generated may be associated with transform data defining, for each respective base subgraph of the plurality of base subgraphs, a transform between the subgraph space for the respective base subgraph and at least one operation-specific local space of the at least one operation of the respective base subgraph. These transforms for example enable efficient mapping of operations across different coordinate systems within the neural network processing framework. This approach allows for more flexible and optimized implementation of tasks by providing clear transformations between different representation spaces. The transform data associated with each base subgraph provides a flexible framework for dimensional mapping within the processing system. By defining precise transforms between subgraph spaces and operation-specific local spaces, the system can maintain dimensional (and transformation) information independently for each base subgraph. This approach allows for more versatile handling of dimensional relationships within a directed graph than previous approaches. These transforms may be used to obtain transforms between a chain space associated with a chain of base subgraphs and respective local spaces of operations within the chain.

Each base subgraph can be structured with well-defined boundaries, beginning with an input operation, ending with an output operation, and comprising at least one operation between these boundary operations. This structure creates self-contained functional units that can be independently verified for correctness before being merged into larger chains. The input operation may obtain input from external storage, and the output operation may write output to external storage, enabling efficient data flow between the neural engine and memory systems.

When merging subgraph spaces, the system may ensure that each dimension of the consumer subgraph space uniquely maps to a corresponding dimension of the producer subgraph space. In cases where a dimension of the consumer subgraph space maps to multiple dimensions of the producer subgraph space, the system can generate an updated producer subgraph by duplicating the producer subgraph and permutating dimensions of the duplicate to ensure unique mappings. Similarly, when a dimension of the producer subgraph space maps to multiple dimensions of the consumer subgraph space, the system can generate an updated producer subgraph with a duplicate dimension replaced by a further dimension to maintain unique mappings.

The chain of base subgraphs can be adjusted to remove redundant aspects, such as unconsumed outputs, non-output operations at branch ends, or unused dimensions. This targeted redundancy elimination optimizes the chain structure without compromising functional correctness. Additionally, the chain can be adjusted to consolidate duplicate portions, reducing redundancy in the operation space and reducing computational overhead.

Non-orthogonal dimensions in the chain space can be combined to reduce the overall dimensionality of the operation space, enabling more complex chains to fit within architectural constraints while preserving computational correctness. Before chaining subgraphs, the system can verify tensor locality by determining that the producer and consumer subgraphs operate on the same portion of a tensor, ensuring data coherence and preventing invalid chains.

Connections between consumer and producer subgraphs can be tagged as associated with sequential operations to be performed by a vector engine, enabling specialized hardware optimizations like vector engine forwarding and improving data transfer efficiency between sequential operations.

The space transformation techniques described for optimizing computational graphs can be implemented with various additional features and variations. These variations extend the capabilities and efficiency of the techniques while maintaining the core functionality of establishing equivalence between local space dimensions and replacing input-output operations with logical pipes.

The description of FIGS. 16 to 24 describes updating a chain of subgraphs. The chain of subgraphs may be generated using the methods herein. For example, the chain of subgraphs may be a chain of base subgraphs. In other cases, though, the chain of subgraphs may be generated using a different method. For example, the chain of subgraphs may be initially generated using a primary operation concept similar to that used in previous chaining approaches, but with augmented transform spaces to retain dimensional information along the chain, as needed or desired, and with adjacent subgraphs chained to each other via output and input operations that are resolved into a logical pipe via dimensional equivalence as described herein.

The processor can compile the task data generated from the updated chain of subgraphs into machine instructions. This compilation process enables direct hardware execution of the optimized graph operations, eliminating interpretation overhead and maximizing processing throughput. By translating the high-level graph representation into low-level machine instructions, the system leverages the full performance capabilities of the underlying hardware.

The processor can include a dedicated graph compiler component that handles the space transformation and optimization process. This specialized compiler obtains the chain data, determines dimensional equivalence, updates the chain of subgraphs based on that equivalence, and generates optimized task data. By using a dedicated compiler designed specifically for graph-based computational models, the system provides targeted optimization capabilities that address the unique characteristics of graph processing workloads.

The task data generated by the processor can be specifically formatted for execution on a graph processor. Graph processors are specialized hardware designed for efficient execution of directed graphs of operations. By generating task data that aligns with the capabilities and requirements of graph processors, the system leverages hardware acceleration for further performance improvements beyond the software-level optimizations provided by the space transformation techniques.

The described methodology can be implemented in a processor configured to perform the chaining and/or chain updating operations, providing hardware-level optimizations of neural network execution. A system comprising the processor may further include an offload processor with a command processing unit connected to a processing module, such as a graph processor, comprising storage elements and execution units. The graph processor may be or comprise a neural processing unit and/or a neural engine. This offload processor integration enables efficient task distribution and specialized processing for complex neural network operations. The command processing unit creates an efficient pipeline for task data handling, while multiple execution units enable parallel processing of chained operations. The processor can compile task data into machine instructions, enabling architecture-specific optimizations before offloading to ensure efficient execution on the target hardware.

The processing module can include a handling unit that maps logical pipes to specific storage elements within the storage. This mapping enables optimized utilization of available storage resources, reducing memory access bottlenecks and improving data transfer efficiency between connected subgraphs. By intelligently allocating storage resources based on the data flow requirements of the logical pipes, the system can increase the performance benefits provided by the pipe-based optimization approach.

The described methodology can also be implemented as computer-readable instructions stored on a non-transitory storage medium, providing flexibility to deploy the approach across different hardware platforms and integrate it into various software frameworks without requiring specialized hardware.

1. A processor configured to:
obtain chain data representative of a chain of subgraphs representative of at least part of a directed graph of operations, the chain of subgraphs associated with a chain space and comprising:
a first subgraph;
an output operation to obtain output data from the first subgraph, the output operation associated with a first local space;
an input operation to obtain the output data from the output operation, the input operation associated with a second local space; and
a second subgraph to obtain the output data from the input operation,
based on the chain data, determine an equivalence between at least one first local space dimension of the first local space to be iterated over to execute the output operation and a corresponding at least one second local space dimension of the second local space to be iterated over to execute the input operation;
based on the equivalence, update the chain of subgraphs to replace at least a combination of the output operation and the input operation with a connection corresponding to a logical pipe connecting the first subgraph to the second subgraph, thereby generating an updated chain of subgraphs; and
based on the updated chain of subgraphs, generate task data that describes a task to be executed in the form of a further directed graph of operations representative of at least the part of the directed graph of operations.

2. The processor of claim 1, wherein, to update the chain of subgraphs, the processor is configured to, based on the equivalence, reduce a chain space dimensionality of the chain space to obtain a condensed chain space with a condensed chain space dimensionality which is less than the chain space dimensionality, the condensed chain space transformable to the chain space using a chain space transform, the updated chain of subgraphs associated with the condensed chain space.

3. The processor of claim 2, wherein the condensed chain space is transformable to the chain space by:
increasing the condensed chain space dimensionality to the chain space dimensionality to generate an intermediate chain space comprising each dimension of the condensed chain space and respective predetermined values for each dimension of the chain space that is absent from the condensed chain space; and
applying the chain space transform to the intermediate chain space to transform the intermediate chain space to the chain space.

4. The processor of claim 1, wherein the processor is configured to, based on the chain data, determine that the equivalence is between the first local space and the second local space.

5. The processor of claim 1, wherein the first local space is to be iterated over in first blocks to execute the output operation and the second local space is to be iterated over in second blocks to execute the input operation and at least one of:
each iteration over a respective first block in the first local space corresponds to a respective iteration over a corresponding second block in the second local space; and
a first block size of the first blocks in the first local space is the same as a second block size of the second blocks in the second local space.

6. The processor of claim 1, wherein the chain space is associated with a first transform to the first local space and a second transform to the second local space, different from the first transform.

7. The processor of claim 6, wherein, to update the chain of subgraphs, the processor is configured to, based on the equivalence, reduce a chain space dimensionality of the chain space to obtain a condensed chain space with a condensed chain space dimensionality which is less than the chain space dimensionality, the condensed chain space transformable to the chain space using a chain space transform, the updated chain of subgraphs associated with the condensed chain space, and
wherein the processor is configured to determine, for the updated chain of subgraphs, a first condensed transform from the condensed chain space to the first local space and a second condensed transform from the condensed chain space to the second local space,
optionally wherein the chain of subgraphs comprises a third subgraph associated with a third local space, the chain space is associated with a third transform to the third local space, and the processor is configured to determine, for the updated chain of subgraphs, a third condensed transform from the condensed chain space to the third local space.

8. The processor of claim 6, wherein the processor is configured to at least one of:
augment the first transform to obtain an augmented first transform to transform the chain space to an augmented first local space comprising the first local space and the chain space; and
augment the second transform to obtain an augmented second transform to transform the chain space to an augmented second local space comprising the second local space and the chain space.

9. The processor of claim 8, wherein the chain space is transformable back to itself, via the first and second augmented local spaces, using one of the augmented first transform and the augmented second transform, and an inverse of the other one of the augmented first transform and the augmented second transform, wherein at least the other one of the augmented first transform and the augmented second transform is surjective.

10. The processor of claim 9, wherein:
(i) the augmented second transform is the one of the augmented first transform and the augmented second transform, and the augmented second transform is surjective; or
(ii) the one of the augmented first transform and the augmented second transform is non-affine.

11. The processor of claim 5, wherein at least one of the first transform and the second transform comprises a plurality of transforms comprising an affine transform and a non-affine transform, optionally a clip operation.

12. The processor of claim 11, wherein at least one of:
(i) the plurality of transforms comprises a further affine transform and the processor is configured to order the plurality of transforms such that the non-affine transform is after the affine transform and the further affine transform; or
(ii) the plurality of transforms comprises a further affine transform and the processor is configured to remove a portion of the affine transform that would be unprojected by the further affine transform, optionally wherein, before removing the portion of the affine transform, the processor is configured to permute elements of the affine transform to increase a size of the portion of the affine transform.

13. The processor of claim 5, wherein:
the first transform is a first affine transform to perform a first identity projection of a first set of dimensions of the chain space to the first local space; and
the second transform is a second affine transform to perform a second identity projection of a second set of dimensions of the chain space to the second local space,
optionally wherein, to determine the equivalence between the at least one first local space dimension and the corresponding at least one second local space dimension, the processor is configured to identify a mapping between at least one dimension of the first set of dimensions and a corresponding at least one dimension of the second set of dimensions.

14. The processor of claim 1, wherein the processor is configured to:
obtain a plurality of base subgraphs based on the directed graph of operations, wherein each base subgraph of the plurality of base subgraphs comprises at least one operation of the directed graph of operations and is associated with a respective subgraph space defined by at least one dimension to be iterated over to execute the respective subgraph, the plurality of base subgraphs comprising:
a producer subgraph comprising a producer operation of the directed graph of operations, for generation of a production output; and
a consumer subgraph comprising a consumer operation of the directed graph of operations, for consumption of the production output;
chain the consumer subgraph to an end of the producer subgraph to generate a chain of base subgraphs, wherein the chaining comprises merging a consumer subgraph space associated with the consumer subgraph with a producer subgraph space associated with the producer subgraph to obtain a base subgraph chain space associated with the chain of base subgraphs; and
obtain the chain data based on the chain of base subgraphs.

15. The processor of claim 1, wherein the processor is configured to compile the task data into machine instructions.

16. The processor of claim 1, wherein the processor is or comprises a graph compiler configured to:
obtain the chain data;
based on the chain data, determine the equivalence between the at least one first local space dimension and the corresponding at least one second local space dimension;
based on the equivalence, update the chain of subgraphs; and
based on the updated chain of subgraphs, generate the task data.

17. A system comprising the processor of claim 1, and an offload processor, the offload processor comprising a command processing unit connected to a processing module, the processing module comprising:
a storage with a plurality of storage elements; and
a plurality of execution units,
wherein the processor is configured to issue the task data to the command processing unit.

18. The system of claim 17, wherein the offload processor is a graph processor, wherein optionally the graph processor comprises a neural engine and/or a neural processing unit.

19. The system of claim 17, wherein the processing module comprises a handling unit configured to map the logical pipe to at least one storage element of the plurality of storage elements of the storage.

20. A method comprising:
obtaining chain data representative of a chain of subgraphs representative of at least part of a directed graph of operations, the chain of subgraphs associated with a chain space and comprising:
a first subgraph;
an output operation to obtain output data from the first subgraph, the output operation associated with a first local space;
an input operation to obtain the output data from the output operation, the input operation associated with a second local space; and
a second subgraph to obtain the output data from the input operation;
based on the chain data, determining an equivalence between at least one first local space dimension of the first local space to be iterated over to execute the output operation and a corresponding at least one second local space dimension of the second local space to be iterated over to execute the input operation;
based on the equivalence, updating the chain of subgraphs to replace at least a combination of the output operation and the input operation with a connection corresponding to a logical pipe connecting the first subgraph to the second subgraph, thereby generating an updated chain of subgraphs; and
based on the updated chain of subgraphs, generating task data that describes a task to be executed in the form of a further directed graph of operations representative of at least the part of the directed graph of operations.
